(19) United States
(12) Patent Application Publication
(10) Pub. No.: US 2026/0039641 A1
(43) Pub. Date: Feb. 5, 2026

(54) AUTHORIZED ACCESS TO SECURITY EVENT DATA

(71) Applicant: Lenovo (Singapore) Pte Ltd., Singapore (SG)

(72) Inventors: Sheeba Backia Mary Baskaran, Friedrichsdorf (DE); Andreas Kunz, Ladenburg (DE)

(73) Assignee: Lenovo (Singapore) Pte Ltd, Singapore (SG)

(21) Appl. No.: 18/789,211

(22) Filed: Jul. 30, 2024

(51) Int. Cl. H04L 9/40; H04L 9/32

(52) U.S. Cl. CPC H04L 63/0807; H04L 9/32

(57) ABSTRACT

Various aspects of the present disclosure relate to authorized access to security event data. An apparatus, such as a network equipment (NE) that implements a first network function (NF) (e.g., a network repository function (NRF)), receives a request from a second NF (e.g., an operator security function (OSF)) for a token to access security event data from a third NF (e.g., an NF service producer). The first NF generates the token using a profile of the second NF. The first NF transmits the token to the second NF. A fourth NF (e.g., a data collection function) can request a second token from the first NF to access the security event data for the second NF. The third NF can transmit the security event data to the second NF via the fourth NF or directly. This enables secure and authorized access to security event data in wireless communication networks.

### TECHNICAL FIELD

The present disclosure relates to wireless communications, and more specifically to monitoring security events.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include an NE to implement a first network function (NF) for wireless communication to receive, from at least one second NF, a request for a token to access security event data corresponding to a third NF, generate the token based on a profile of the at least one second NF indicating that the at least one second NF is authorized to access the security event data (e.g., to perform security evaluation and monitoring), and transmit, to the at least one second NF, the token.

In some implementations of the method and apparatuses described herein, the NE receives, from a fourth NF, an additional request for an additional token to access the security event data (e.g., to access the security event data for data collection and to notify the collected data to second NF that performs security evaluation and monitoring), generates the additional token based on a profile of the fourth NF indicating that the fourth NF is authorized to access the security event data, and transmits, to the fourth NF, the additional token. Additionally, or alternatively, the first NF is a network repository function (NRF), the at least one second NF is at least one operator security function (OSF), the third NF is an NF service producer, and the fourth NF is a data collection function (e.g., a security event data collection function). Additionally, or alternatively, the profile of the fourth NF includes a set of IEs that indicate at least one of an NF type associated with collection of the security event data, an authorized service associated with the collection, exposure, or notification of the security event data, one or more authorized security event identifiers (IDs) associated with the collection, the exposure, or the notification of the security event data, information associated with the third NF that indicates the third NF is authorized to consume a security event data collection service or a notification service to perform security evaluation and monitoring, an expected service associated with the exposure of the security event data, one or more IDs associated with the security event data, or an expected mode associated with the security event data. Additionally, or alternatively, the token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that indicates the at least one second NF is authorized to access the security event data, or an ID associated with the fourth NF that indicates the fourth NF is authorized to access the security event data.

Additionally, or alternatively, the profile of the at least one second NF includes a set of IEs that indicates at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data. Additionally, or alternatively, the first NF is an NRF, the at least one second NF is at least one of a data collection function or an OSF, and the third NF is an NF service producer.

Some implementations of the method and apparatuses described herein may further include a NE to implement a first NF for wireless communication to transmit, to a second NF, a request for a token to access security event data corresponding to a third NF, and receive the token based on a profile of the first NF indicating that the first NF is authorized to access the security event data.

In some implementations of the method and apparatuses described herein, the NE transmits, to at least one of the second NF or a fourth NF, a request for the security event data, the request for the security event data including the token, and receives, in response to the request for the security event data, the security event data, where the first NF is an OSF, the second NF is an NRF, the third NF is an NF service producer, and the fourth NF is a data collection function (e.g., a security event data collection function). Additionally, or alternatively, the profile of the first NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data.

Additionally, or alternatively, the token includes one or more parameters that indicate services associated with collection, exposure, or notification of the security event data that the first NF is authorized to access, an authorized target reporting type, one or more IDs associated with the security event data that the first NF is authorized to access, or an ID associated with the first NF that indicates the first NF is authorized to access the security event data. Additionally, or alternatively, the first NF is an OSF, the second NF is an NRF, and the third NF is an NF service producer.

Some implementations of the method and apparatuses described herein may further include a NE to implement a first NF for wireless communication to receive, from at least one second NF, a first request for security event data corresponding to a third NF, where the first request for the security event data includes a first token based on a profile of the at least one second NF indicating that the at least one second NF is authorized to access the security event data, transmit, to the third NF, a second request for the security event data, where the second request for the security event data includes a second token based on a profile of the at least one second NF and a profile of the first NF indicating that the at least one second NF and the first NF are authorized to access the security event data, receive, from the third NF, the security event data, and transmit, to the at least one second NF, the security event data.

In some implementations of the method and apparatuses described herein, the NE transmits, to a fourth NF, a request for the second token, and receives, in response to the request for the second token, the second token, where the first NF is a data collection function (e.g., a security event data collection function), the at least one second NF is an OSF, the third NF is an NF service producer, and the fourth NF is an NRF. Additionally, or alternatively, the profile of the first NF includes a set of IEs that indicate at least one of an NF type associated with collection of the security event data, an authorized service associated with the collection, exposure, or notification of the security event data, an authorized target reporting type, one or more authorized security event IDs associated with the collection, the exposure, or the notification of the security event data, one or more IDs associated with the security event data, an ID associated with the second NF that indicates the second NF is authorized to access the security event data, an expected service associated with the exposure of the security event data, or an expected mode associated with the security event data.

Additionally, or alternatively, the profile of the at least one second NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with the security event data, an expected target reporting type, an expected mode associated with the security event data, or information corresponding to the collection of the security event data. Additionally, or alternatively, the first token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that is authorized to access the security event data. Additionally, or alternatively, the second token includes one or more parameters that indicate services associated with the security event data that the at least one second NF and the first NF are authorized to access, one or more IDs associated with the security event data that the at least one second NF and the first NF are authorized to access, or respective IDs associated with the second NF and the first NF that indicate the second NF and the first NF are authorized to access the security event data. Additionally, or alternatively, the first NF is a data collection function (e.g., a security event data collection function), the at least one second NF is an OSF, and the third NF is an NF service producer.

Some implementations of the method and apparatuses described herein may further include a NE to implement a first NF for wireless communication to receive, from a second NF, a request for security event data, where the request for the security event data includes a token based on a profile of the second NF indicating that the second NF is authorized to access the security event data, and transmit, to the second NF, the security event data.

In some implementations of the method and apparatuses described herein, the request for the security event data includes the token based on a profile of a third NF indicating that the third NF is authorized to access the security event data, the first NF is an NF service producer, the second NF is a data collection function (e.g., a security event data collection function), and the third NF is an OSF, and the token includes one or more parameters that indicate services associated with exposure of the security event data that the second NF is authorized to access, an ID associated with the second NF that indicates the second NF is authorized to access and collect the security event data (e.g., to access the security event data for data collection and to notify the collected data to third NF that performs security evaluation and monitoring), an ID associated with the third NF that indicates the third NF is authorized to access the security event data, or one or more IDs associated with the security event data that the second NF is authorized to access.

Additionally, or alternatively, the profile of the second NF includes a set of IEs that indicate at least one of an authorized service associated with collection, exposure, or notification of the security event data, that logging the security event data is supported, that logging the security event data is not supported, one or more IDs associated with the security event data to be exposed, an expected mode associated with the collection of the security event data, one or more IDs associated with one or more NFs that are authorized to access the security event data, or information corresponding to the collection of the security event data. Additionally, or alternatively, the first NF verifies the token by checking if one or more parameters indicated by the token match one or more parameters indicated by the request for the security event data, and where the first NF is an NF service producer and the second NF is at least one of a data collection function (e.g., a security event data collection function) or an OSF.

### BRIEF DESCRIPTION OF THE DRAWINGS

FIG. 1 illustrates an example of a wireless communications system in accordance with aspects of the present disclosure.

FIG. 2 illustrates an example of a service based architecture (SBA) diagram, in accordance with aspects of the present disclosure.

FIGS. 3 through 6 illustrate examples of signaling diagrams, in accordance with aspects of the present disclosure.

FIG. 7 illustrates an example of a processor in accordance with aspects of the present disclosure.

FIG. 8 illustrates an example of a NE in accordance with aspects of the present disclosure.

FIGS. 9 through 12 illustrate flowcharts of a method performed by a NE in accordance with aspects of the present disclosure.

### DETAILED DESCRIPTION

A wireless communications system may include one or more devices, such as one or more UEs and NEs, that communicate control information and data. The NEs may implement hardware and/or software components, referred to as NFs, to facilitate and manage the communication of the control information and the data. The NFs may be organized into a layer architecture, with different layers responsible for defined services or tasks. For example, a core network (CN) layer may include one or more NFs that provide authentication, authorization, and accounting services, as well as routing and forwarding of user data. The NFs in the CN may be independently deployed in an SBA, such that the NFs communicate with one another to provide respective services. The NFs in the SBA may be NF service producers that offer services to other NFs and/or NF service consumers that use services provided by the NF service producers to fulfill one or more services or tasks.

In some examples, the wireless communications system may support security monitoring at one or more NFs, which involves collecting security event data from NFs to detect abnormal events or malicious behaviors. However, conventional authorization mechanisms defined for NF service consumers to access services of NF service producers do not verify if an NF service consumer is permitted to access security event data exposure services. This lack of verification may lead to unauthorized entities accessing sensitive security and privacy data, potentially exposing network vulnerabilities, threat surfaces, and subscriber information.

To reduce or prevent access to security event data by unauthorized entities, a wireless communications system may implement a security authorization procedure. For example, an authorization server, such as an NRF, may receive a request from a security event data consumer for a token that indicates the OSF is authorized to access the security event data. The security event data consumer may be an example of an NF service consumer, including an OSF. The NRF may generate and transmit the token to the OSF. In some examples, the wireless communications system may include a data collection function that acts as an intermediate data collection and storage entity for an OSF. The OSF may transmit a request to the data collection function that includes the token and indicates for the data collection function to obtain security event data. The data collection function obtains an additional token from the NRF that may be used to verify the data collection function and the OSF are both authorized to access the security event data. The data collection function transmits a request to one or more NF service producers that includes the additional token and requests the security event data. If the data collection function and the OSF are authorized to access the security event data, then the NF service producer transmits the security event data to the data collection function. The data collection function transmits (e.g., forwards) the security event data to the OSF.

In a wireless communications system, one or more NFs in an SBA may support wireless communications via one or more logical and/or physical connections. For example, the logical connections may be implemented via software, including application programming interfaces (APIs) and protocols. Additionally, or alternatively, the physical connections may be implemented via wired communication links, including physical infrastructure utilizing fiber optic or other connections within data centers or between network sites.

Aspects of the present disclosure are described in the context of a wireless communications system.

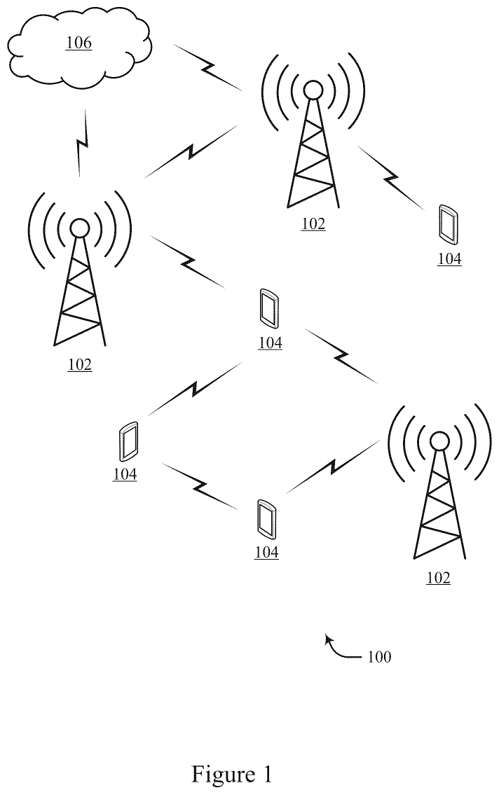

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GH2), and FR5 (114.25 GHZ-300 GHZ). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, the NEs 102 implement various NFs as part of an SBA, while the UEs 104 access these NFs through the NEs 102. NFs are software and/or hardware components that perform tasks within the wireless communications system 100, such as managing user authentication, handling data routing, or enforcing network policies. The SBA organizes the NFs as a collection of interconnected services, providing for the NFs to communicate and interact using standardized interfaces and protocols. For example, NFs implemented at or by the NEs 102 may include functions for radio resource management, mobility management, and session management. The UEs 104 interact with the NFs by communicating with the NEs 102, which act as access points to the services provided by the wireless communications system 100. The CN 106 may host NFs that support the operations of the CN 106. An SBA approach increases flexibility, scalability, and efficiency of the wireless communications system 100, as NFs may be deployed, updated, and scaled independently across the network components while maintaining consistent access for the UEs 104.

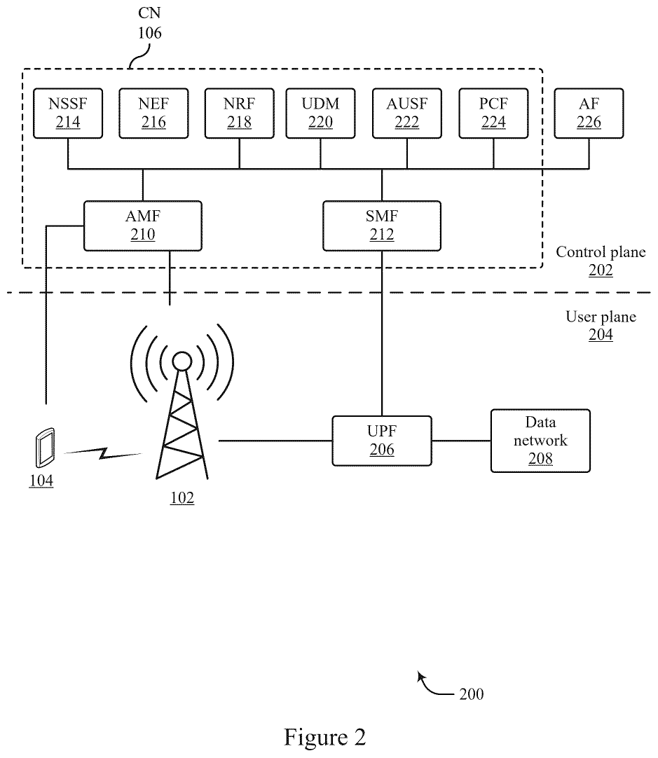

In an SBA, NFs may act as NF service consumers and/or NF service producers. NF service producers offer services to other NFs, while NF service consumers use services provided by NF service producers to perform tasks or responsibilities. This relationship enables a modular and flexible approach to network operations. For example, an AMF may act as an NF service producer when providing registration and mobility management services to UEs 104, while simultaneously acting as an NF service consumer when requesting authentication services from an authentication server function (AUSF). Similarly, a policy control function (PCF) may be an NF service producer when offering policy rules to a session management function (SMF), but the PCF may also be an NF service consumer when requesting subscription data from a unified data management (UDM) function. This consumer-producer relationship provides for efficient communication and service delivery within the wireless communications system 100, promoting scalability and easier integration of new services, which is described in further detail with respect to FIG. 2.

In some examples, the wireless communication system 100 may implement a security monitoring service at various NFs to detect abnormal events or malicious behaviors. However, conventional authorization mechanisms defined for NF service consumers to access services of NF service producers do not adequately verify if an NF service consumer is permitted to access security event data exposure services. This lack of verification may lead to unauthorized entities accessing sensitive security and privacy data, potentially exposing network vulnerabilities, threat surfaces, and subscriber information. Consequently, there is a need for an improved security authorization procedure that may effectively control and manage access to security event data within the SBA framework, ensuring that only authorized entities may collect, process, and analyze the information.

To address the security concerns related to accessing security event data in an SBA network, the wireless communications system 100 may implement a token-based authentication and authorization mechanism for security event data access. An authorization server, such as an NRF, may generate and issue tokens to NFs that request access to security event data. The NRF may verify that the NF requesting a token is authorized to access the security event data using information in a profile of the NF. The token may indicate the security event data and services the NF is authorized to access. When an NF service consumer, such as an OSF and/or a data collection function, requests security event data from an NF service producer, the OSF and/or the data collection function presents the token with the request. The NF service producer then verifies the token to ensure the requesting NF is authorized to access the security event data before granting access to the security event data. This approach enhances the overall security of the system by providing fine-grained access control, reducing the risk of unauthorized access to sensitive information, and maintaining the flexibility and efficiency of the SBA framework.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of an SBA diagram 200 in accordance with aspects of the present disclosure. In some examples, the SBA diagram 200 implements or is implemented by aspects of the wireless communications system 100. For example, SBA diagram 200 may be implemented by a UE 104 and a NE 102, which may be examples of a UE 104 and a NE 102 as described with reference to FIG. 1.

The UE 104 and the NE 102 may exchange signaling, including control signaling and/or data, via a wireless communications link. To support the exchange of signaling between the UE 104 and the NE 102, a wireless communications system may implement a control plane 202 and a user plane 204. The control plane 202 may implement an SBA and may be responsible for signaling and control functions that establish, maintain, and terminate connections or sessions for communications between devices (e.g., the UE 104 and the NE 102) in a wireless communications system. The control plane 202 may perform tasks, such as authentication, authorization, mobility management, and session management. The control plane 202 may process and route control messages between NFs, or other network elements, to set up and manage communication links. The user plane 204, also known as the data plane, may be responsible for carrying user data traffic. The user plane 204 may perform the transmission of data packets between devices and may perform functions, such as packet routing, forwarding, and quality of service management.

A UE 104 may communicate with a NE 102 over an air interface, sending data traffic via both a control plane 202 and a user plane 204. The NE 102 may process control plane data traffic from the UE 104 and may forward them to appropriate NFs in a CN 106 (e.g., a CN 106, as described with reference to FIG. 1). For user plane data traffic, the NE 102 may forward data packets from the UE 104 to a user plane function (UPF) 206. The UPF 206 may serve as an anchor point for user plane data traffic. That is, the UPF 206 may receive data packets from the NE 102 and may route (e.g., forward) the data packets to a data network 208. The NE 102 may maintain separate logical connections for control plane and user plane data traffic with the NFs in the CN 106. The NE 102 and NFs in the CN 106 may exchange control plane data traffic, while the NE 102 and the UPF 206 may exchange user data. The data network 208 may represent an external network or service that the UE 104 is accessing. User plane data traffic may flow from the UE 104 through the NE 102 and the UPF 206 to reach the data network 208.

In some examples, the CN 106 may include multiple NFs in an SBA. For example, the CN 106 may include an AMF 210 and an SMF 212. An AMF 210 in a control plane 202 may be responsible for handling access control and mobility management tasks. The AMF 210 may authenticate and authorize UEs 104, manage UE registration and reachability, and handle mobility events such as handovers. The AMF 210 may also terminate a control plane interface from a RAN and may route messages between the UE 104, the NE 102, and other NFs. An SMF 212 in a control plane 202 may be responsible for managing user sessions and data connectivity. The SMF 212 may establish, modify, and release user plane sessions, allocate internet protocol (IP) addresses to UEs 104, and select and control the UPF 206 for data routing. The SMF 212 may also enforce policies related to session management and may interact with other NFs to coordinate service delivery.

In a control plane 202, one or more NFs may interact with the AMF 210 and the SMF 212 to support wireless communications. For example, a network slice selection function (NSSF) 214 may assist in selecting a network slice for a UE 104. The NSSF 214 may interact with the AMF 210 to provide slice selection information during UE registration and session establishment. A network exposure function (NEF) 216 may expose network capabilities and services to external applications. The NEF 216 may interact with the AMF 210 and SMF 212 to facilitate access to network services and information. A NRF 218 may maintain a repository of available NF services. The NRF 218 may assist the AMF 210 and SMF 212 in discovering and selecting other NFs. A UDM 220 may store and manage subscriber data. The UDM 220 may interact with the AMF 210 for authentication and authorization, and with the SMF 212 for subscription information related to session management. An authentication server function (AUSF) 222 may handle UE authentication. The AUSF 222 may interact with the AMF 210 during an authentication process for UEs 104 accessing the network. A policy control function (PCF) 224 may provide policy rules to control network behavior. The PCF 224 may interact with the AMF 210 for access and mobility policies, and with the SMF 212 for session management policies. An application function (AF) 226 may represent applications that include dynamic policy and charging control. The AF 226 may interact with the SMF 212 via the PCF 224 to influence session management based on application requirements. These NFs may communicate with the AMF 210 and SMF 212 through one or more interfaces, enabling a flexible and modular network architecture.

In some examples, the CN 106 may implement the NFs (e.g., the NSSF 214, the NEF 216, the NRF 218, the UDM 220, the AUSF 222, the PCF 224, the AMF 210, and/or the SMF 212, among others) to provide a variety of services to support wireless communications. Some example services provided by the CN 106 include, but are not limited to, authentication and authorization services, which may verify the identity of UEs 104 and determine access authority, mobility management services, which may track locations of UEs 104 and manage handovers between different network areas, session management services, which may establish, maintain, and terminate data sessions for UEs 104, IP address allocation and management for UEs 104 connecting to the network, policy enforcement services, which may apply network policies to user traffic and sessions, and network exposure services, which may provide for third-party applications to access network information or capabilities, among others.

In some cases, the services may include security monitoring (e.g., security event data evaluation and monitoring), during which one or more NFs collect security event data from the network. The security event data is data that indicates one or more abnormal events and/or malicious behaviors related to the NFs. The security event data can include, but is not limited to, data that indicates authentication failures or anomalies, such as repeated failed login attempts, unusual traffic patterns or sudden spikes in network activity, detected malware or virus infections within the network, unauthorized access attempts to restricted network resources, changes in device configurations or unexpected software installations, abnormal user behavior patterns that may indicate account compromise, encryption failures or weaknesses detected in communication channels, and resource utilization exceeding a threshold value at one or more NFs or UEs 104, among others. The NFs may collect the security event data from NF service producers, which may include other NFs in the CN 106, an AF 226, and RAN functions, among other examples, to perform security monitoring. The security event data may disclose the network vulnerabilities, threat surface, and/or privacy sensitive data (e.g., subscriber data or network topology, among other examples), leading to consequences if exposed to unauthorized entities or NFs.

In some examples, a wireless communications system may implement authorization mechanisms (e.g., based on tokens) to authorize network service access (e.g., in an SBA architecture). Both the NF service consumer and the NF service producer are registered in the NRF 218, which performs the role of an authorization server. For security monitoring, the NF or network entity that performs the security monitoring (e.g., an OSF) may reside external to the network or may not be part of the SBA. The OSF may still receive security event data from the NF service producers (e.g., either directly or via a data collection function located in the SBA). Conventional authorization mechanisms do not provide for security event exposure and/or collection to an NF or a network entity external to the network. Thus, conventional techniques for implementing security event data collection and exposure do not verify if an NF service consumer is authorized (e.g., allowed, permitted) to consume a security event data exposure service or not. This lack of sufficient authorization mechanism and authorization verification for the security event data exposure service access may lead to security and privacy issues due to data access by unauthorized entities.

An NF service consumer obtains a token, also referred to as an access token, before service access to NF service producers of a defined NF type. The NF service consumer transmits a message to the NRF 218 that requests a token from the NRF 218 in a same public land mobile network (PLMN) using a token request operation (e.g., Nnrf_AccessToken_Get request operation). The message includes the NF instance IDs of the NF service consumer, the requested scope including the expected NF service names and optionally additional scope information (e.g., requested resources and requested actions, or service operations, on the resources), an NF type of the expected NF service producer instance, and an NF service consumer. The NF service consumer may also include a list of single network slice selection assistance information (S-NSSAIs) or a list of network slice instance (NSI) IDs for the expected NF service producer instances. The message may include an NF set ID and/or an NF service set ID of the expected NF service producer instances.

The NRF 218 verifies that the input parameters NF instance ID and NF type, as well as PLMN IDs, if available, in the token request match with the corresponding ones in a public key certificate of the NF service consumer or those in an NF profile of the NF service consumer. If the verification of the parameters in the token request fails, then the token request is not further processed. The NRF 218 may additionally, or alternatively, verify the S-NSSAIs of the NF service consumer and check whether the NF service consumer is authorized to access the services of an NF service producer of a defined NF type (e.g., depending on the slices for which the NF service producer offers services). The NRF 218 checks whether the NF service consumer is authorized to access the requested services. For example, the NRF 218 may verify that the NF service consumer may serve a slice included in the authorized (e.g., allowed, permitted) slices for the NF service producer of a defined NF type. If the NF service consumer is authorized, then the NRF 218 generates a token that includes corresponding claims. The NRF 218 digitally signs the generated token using a shared secret or private key. If the NF service consumer is not authorized, then the NRF 218 does not issue a token to the NF service consumer.

The claims in the token may include an NF instance ID of the NRF 218 (e.g., the issuer), an NF instance ID of the NF service consumer (e.g., the subject), an NF type of the NF service producer (e.g., the audience), one or more expected service names (e.g., a scope), an expiration time, and optionally additional scope information (e.g., authorized resources and authorized actions, or service operations, on the resources). The claims may include a list of S-NSSAIs or NSI IDs for the expected NF service producer instances. The claims may include the NF set ID and/or NF service set ID of the expected NF service producer instances. If the authorization is successful, then the NRF 218 sends the token to the NF service consumer in a response message (e.g., an Nnrf_AccessToken_Get response operation). Otherwise, the NRF 218 replies with an error response (e.g., Oauth 2.0 error response).

The NF service consumer may store the received tokens. The stored tokens may be reused for accessing one or more services from an NF service producer NF type listed in the claims (e.g., scope, audience) during the validity time. An NF service consumer may request a service using the token, which is referred to as a service access request. Prior to the service access request, the NF service consumer may perform a discovery operation (e.g., Nnrf_NFDiscovery_Request operation) with the requested additional scopes to select an NF service producer (e.g., resource server) that is able to authorize the service access request. The NF service consumer may be in possession of a valid token before requesting service access from the NF service producer. The NF service consumer requests service from the NF service producer. The NF service consumer shall include the token. The NF service consumer and NF service producer perform an authentication using the token. For example, the NF service producer verifies the token by ensuring the integrity of the token (e.g., verifying a signature in the token using the public key of the NRF 218 or checking the medium access control (MAC) value using a shared secret). If the integrity check is successful, then the NF service producer verifies the claims in the token.

In a direct communication case, the NF service producer verifies the claims by checking that the NF instance ID in the subject claim within the token matches the NF instance ID in the subjectAltName in a transport layer security (TLS) client certificate of the NF service consumer. The NF service producer checks that the audience claim in the token matches an identity of the NF service producer or a type of NF service producer. If a list of S-NSSAIs or a list of NSI IDs is present, then the NF service producer checks that the NF service producer serves the corresponding one or more slices. When the request is for information related to a specific UE 104, the NF service producer may check that the NF service consumer is authorized to access (e.g., as indicated by the NF service producer's S-NSSAIs in the token presented by the NF service consumer) at least one of the slices that the UE 104 is currently registered to (e.g., by verifying that the authorized NSSAI(s) of the UE 104 intersect with the S-NSSAIs of the NF service producer in the token). If an NF set ID present, then the NF service producer checks the NF set ID in the claim matches its own NF set ID. If an NF service set ID present, then the NF service producer checks if the NF service consumer is authorized to access the requested service according to NF service producer service set ID in the token claim. If scope is present, then the NF service producer checks that the scope matches the requested service operation. If the token contains additional scope information (e.g., authorized resources and authorized actions, or service operations, on the resources), then the NF service producer checks that the additional scope matches the requested service operation. The NF service producer checks that the token has not expired by verifying the expiration time in the token against the current data and/or time. If a client credentials assertion (CCA) is present in the service request, then the NF service producer may verify that the CCA as defined and that the subject claim (e.g., the NF instance ID of the NF service consumer) in the token matches the subject claim in the CCA. If the verification is successful, then the NF service producer executes the requested service and responds back to the NF service consumer. Otherwise, the NF service producer replies with an error response (e.g., an Oauth 2.0 error response).

In some examples, an NF service consumer may implement a data collection function to access, store, or otherwise collect data from an NF service producer. For example, an NF service consumer sends a request to the NRF 218 to receive a token to request services of data collection function to be used for data collection request. The NRF 218 verifies the NF service consumer is authorized to receive the token and generates the token. The NRF 218 sends the token to the NF service consumer. The NF service consumer initiates an NF service request to the data collection function, which includes the token (e.g., an access_token_nwdaf). The NF service consumer generates a CCA token (e.g., CCA_NWDAF) and includes the CCA token in the request message to authenticate the NF service consumer at the NF service producers.

The data collection function verifies if the token (e.g., the access_token_nwdaf) is valid and executes the service. If the NRF 218 does not support authorization of the source NF (e.g., a network data analytics function (NWDAF)) for data access via the data collection function, then the data collection function authorizes the data access of the NF service consumer. The data collection function determines one or more NF service producers from where the data is to be collected. In some cases, if the NF service consumer sends the NF service producer information (e.g., NF service producer type and instance ID with the service request, then the data collection function does not determine the NF service producer. Instead, the data collection function requests a token from the NRF 218 using the NF service producer details sent by the NF service consumer. The data collection function sends a token request message (e.g., Nnrf_AccessToken_Get request) to the NRF 218 that includes the information to identify the target NF (e.g., the NF service producer), the source NF (e.g., the NF service consumer, NWDAF), the NF instance ID of the data collection function, and the CCA token (e.g., the CCA_NWDAF) provided by the NF service consumer. A parameter (e.g., an nfInstanceld attribute) in an information element (IE) in the token request message (e.g., Nnrf_AccessToken_Get) indicates the NF instance ID of the data collection function as an intermediate NF service consumer, whereas the parameter (e.g., a sourceNfInstanceld attribute) in the IE indicates the source NF instance ID (e.g., NF service consumer, NWDAF).

The NRF may verify whether the data collection function and the NF service consumer (e.g., NWDAF) are authorized to access the service provided by the identified NF service producers, and whether the data collection function is permitted to act as a proxy to request the service on behalf of the NF service consumer. Authentication of both the data collection function and NWDAF may be performed by the NRF. An NRF 218 may authenticate and authorize the data collection function, validating whether the data collection function is authorized to receive the requested service from the NF service producer, without validating the authorization of the source NF service consumer. Upon successful verification, the NRF 218 may generate and provide a token to the data collection function. This token may include the NF instance ID of the data collection function as the subject, and an additional claim containing the identity of the source NF service consumer, authorizing both to consume the services of the NF service producer. For one or more NRFs 218, the generated token may include the data collection function as the subject, without an additional claim for the identity of the source NF service consumer.

The data collection function may then request service from the NF service producer, including the content of the CCA token (e.g., CCA_NWDAF) to provide authentication of the NF service consumer. The NF service producer may verify the subject claim of the CCA token against the token claim conveying the source NF instance ID, when present. The NF service producer may authenticate the NF service consumer and ensure the source NF service consumer identity is included as an additional token claim. Upon successful authentication and authorization, the NF service producer may execute the service and provide the requested data to the data collection function. The data collection function may then forward the received data to one or more NF service consumers. For new NF service consumers requesting data that has already being collected, the NF service producer may authenticate the new NF service consumer, verify the provided token, and send a verification response to the data collection function. Based on this response, the data collection function may update the subscription information to include the new NF service consumer and send data to the new NF service consumers or may reject the request for token verification failure.

In some examples, the NFs in the CN 106 may support data collection and exposure for security evaluation and monitoring (e.g., timely attack and/or threat detection). An existing function, such as an NWDAF, or a new function may offer services to collect and provide security event data to enable OSF-based security evaluation and monitoring. According to operator policy, the function (e.g., the NWDAF or the new function) may subscribe to an NF or an OAM (e.g., a data producer) for event exposure services related to security events, including an authentication and authorization failure event, a reconnaissance detected authentication and authorization event, a malformed service-based interface (SBI) message event, a message and service load event, and/or an abnormal SBI call flow event. The function may subscribe to the NFs to be notified for data collection on related security events. For each security event, if a related event occurs, the NF may notify its own NF ID, event ID, time stamp, and event data (e.g., as report or security logs). The event data for various security events may include information, such as references to specific clauses, related key performance indicators (KPIs) or metrics, and additional data based on operator policy.

The function may collect relevant management data from OAM services based on operator policy for security events as configured by the PLMN operator. The function may have an implicit subscription to the OSF to provide security event data, based on operator policy. The function may send the collected data for security events to the OSF. To provide for the OSF to consume the security event data exposure service, an implicit subscription may exist based on operator policy or explicit subscription. The function may receive an acknowledgement response from the OSF. However, security event data collection by an external entity, such as OSF, may not be authorized (e.g., by the NRF 218 or by another NF).

To authorize security event data collection by an OSF, the wireless communications system may implement a token-based authentication and authorization mechanism for security event data access. An authorization server, such as an NRF 218, may generate and issue tokens to NFs that request access to security event data. The NRF 218 may verify that the NF requesting a token is authorized to access the security event data using information in a profile of the NF. The token may indicate the security event data and services the NF is authorized to access. When an NF service consumer, such as an OSF and/or a data collection function, requests security event data from an NF service producer, the OSF and/or the data collection function presents the token with the request. The NF service producer then verifies the token to ensure the requesting NF is authorized to access the security event data before granting access to the security event data. This approach enhances the overall security of the system by providing fine-grained access control, reducing the risk of unauthorized access to sensitive information, and maintaining the flexibility and efficiency of the SBA framework.

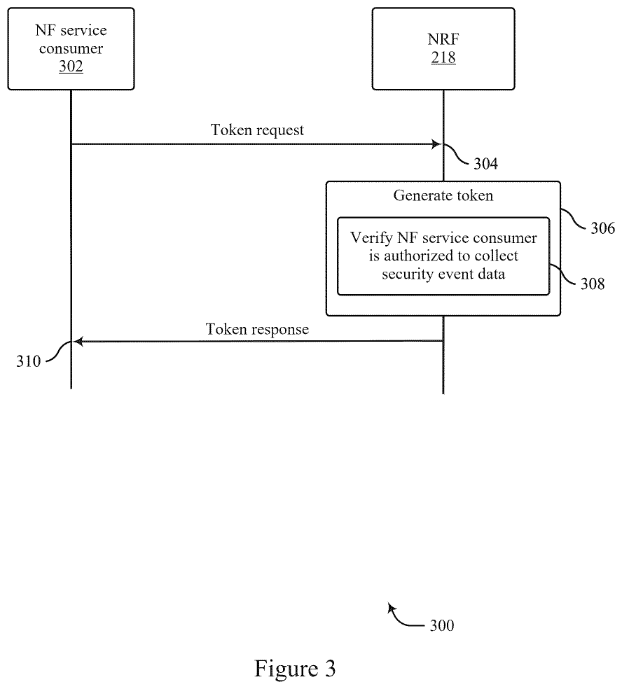

FIG. 3 illustrates an example of a signaling diagram 300 in accordance with aspects of the present disclosure. In some examples, the signaling diagram 300 may implement aspects of the wireless communications system 100 and the SBA diagram 200. The signaling diagram 300 may illustrate an example of an NF service consumer and an NRF 218 implementing token generation for security event data collection in a wireless communications system, where the NRF 218 may be an example of an NRF 218 as described with reference to FIG. 2. Alternative examples of the following may be implemented, where some processes are performed in a different order than described or are not performed. In some cases, processes may include additional features not mentioned below, or further processes may be added.

In some examples, the NF service consumer 302 may be an example of one or more OSFs. In some other examples, the NF service consumer 302 may be an example of one or more data collection functions. Although one NF service consumer 302 is illustrated, any numerical quantity of NF service consumers may implement token generation techniques.

At 304, an NF service consumer 302 transmits a token request to an NRF 218. The token request may be an example of an Nnrf_AccessToken_Get request and may include one or more parameters. Example parameters include, but are not limited to, one or more expected NF service names (e.g., security event data exposure) and NF type, a consumer NF type (e.g., data collection function and/or OSF), a client ID, an NF consumer ID, an NF consumer address, an NF consumer fully qualified domain name (FQDN), and security event IDs, among others.

At 306, the NRF 218 generates the token. For example, at 308, the NRF 218 verifies the NF service consumer 302 is authorized to collect security event data. If the NF service consumer 302 is authorized to collect the security event data, then the NRF 218 generates the token. If the NF service consumer 302 is not authorized to collect the security event data, then the NRF 218 transmits an error message (e.g., to the NF service consumer 302 and/or to another NF).

At 310, the NRF 218 transmits a token response to the NF service consumer 302. The token response may be an example of an Nnrf_AccessToken_Get response and may include one or more parameters. Example parameters include, but are not limited to, security event data exposure as authorized services, an NF consumer ID (e.g., of a data collection function and/or of an OSF), an NF consumer address, an NF consumer FQDN, and security event IDs, among others.

A data collection function may be implemented in two different techniques, a direct case and an indirect case. In the direct case, the security event data collection function is co-located with an OSF and considered part of the network, while the rest of the OSF performing security evaluation and monitoring may be internal or external to the network. The security event data collection function is configured based on operator policy for event exposure and/or notification services to the OSF related to various security events (e.g., authentication and authorization failure, reconnaissance detected authentication and authorization, malformed SBI message, message and service load, and abnormal SBI call flow events). These events are identified with event IDs. In the indirect case, the security event data collection function and the OSF are assumed to be standalone, with the data collection function is considered part of the network and the rest of the OSF may be internal or external to the network. The data collection function may be configured based on operator policy for event exposure and/or notification services to the OSF, or the OSF may have subscribed to security monitoring event data exposure collection and/or notification services for a set of security event IDs.

In both cases, to obtain a token for the security event data collection function, an NRF 218 authorizes the security event data collection. The process involves an NF service consumer 302 (e.g., a security event data collection function) requesting a token from the NRF 218 in a same PLMN using the Nnrf_AccessToken_Get request operation. The request includes various parameters, such as NF Instance IDs of the NF service consumer 302, a requested scope including the expected NF service names indicating security event data exposure or security event data collection exposure services, additional scope information (e.g., requested resources and requested actions, or service operations, on the resources), an NF type of an expected NF service producer instance and NF type of the NF service consumer 302 (e.g., as a data collection function). If the data collection function supports security evaluation and monitoring features and based on operator policy being configured to collect security event data, the data collection function sends an NF service indirect and/or secondary consumer OSF information (e.g., ID, address, FQDN), and an expected list of security event IDs. Additionally, or alternatively, the NF service consumer 302 may include a list of S-NSSAIs or a list of NSI IDs for the expected NF service producer instances in the request. The request may include the NF set ID and/or NF service set Id of the expected NF service producer instances. The request may include a list of S-NSSAIs of the NF service consumer 302. The message may also include the PLMN IDs of the NF service consumer 302.

In some examples, prior to transmitting the token request to the NRF 218, the NF service consumer 302 (e.g., a data collection function) may receive a request (e.g., security event data subscription and/or request) message from an OSF with a CCA token (e.g., an OSF_CCA) and security event IDs. The authentication between the OSF and NF service consumer 302 may be based on TLS or IPSec or based on CCA. Similarly authentication between security event data collection and NRF may be based on TLS or IPSec (internet protocol security) or based on CCA.

Additionally, or alternatively, the NF service consumer 302 (e.g., OSF) authorization verification by the NRF 218 is based on an operator configuration. For example, at 304, a data collection function includes OSF identification information (e.g., an OSF ID, address, FQDN) based on the local operator configuration, which indicates to the NRF 218 that the OSF is the source consumer of the requested security event data. At 306, the NRF 218 verifies the received OSF ID, such that if the OSF ID matches, then the OSF is authorized as a source consumer for security event data in an enhanced NF profile of the NF service producer and/or the NF service consumer (e.g., or a local configuration at the NRF 218).

An enhanced NF profile of an NF (e.g., an NF service producer and an NF service consumer 302), as well as enhanced token claims, enable an OSF and/or a data collection function authorization and verification to consume a security event data exposure service from one or more NF service producers. The enhanced NF profile of the NF service producer includes one or more new IEs. For example, the enhanced NF profile includes IEs that indicate an authorized security event data exposure service, security event data logging and exposure feature support information (e.g., an authorized security event IDs list), an authorized security event data collection mode (e.g., direct by an OSF or indirect via a data collection function), an authorized and/or expected security event data collection function type (e.g., NWDAF, data collection function, security event data collection function, messaging framework adaptor function (MFAF), or any designated data collection network function in the network) for security event data exposure services, which may also include the data collection function information (e.g., ID, network instance ID, FQDN, address), and authorized OSF information (e.g., ID, FQDN, address) as a new IE or indicated as part of an existing IE if security event data exposure service is authorized to be consumed by the OSF either directly or via a data collection function.

The enhanced NF profile of the NF service consumer 302 (e.g., security event data exposure service consumer, such as OSF, security event data collection function, OSF with a co-located data collection function) includes different sets of new IEs depending on whether the NF service consumer 302 is a data collection function (e.g., security event data collection function) or an OSF. If the NF service consumer 302 is a data collection function, then example new IEs may include, but are not limited to, an NF type indicated as security event data collection network function and/or agent or if the data collection function is an existing NF, the NFServices or NFServicesList includes security event data collection and/or exposure or notification services, an expected security event data exposure service, an authorized security monitoring event data collection, exposure, or notification services, an expected and authorized security event IDs lists, an expected security event data collection mode, and authorized OSF information if security event data notification service is authorized to an OSF. If the NF service consumer 302 is an OSF, then example the new IEs may include, but are not limited to, an NF type indicated as OSF, OSF identification information, one or more expected security monitoring event data collection and/or exposure services, an expected security event IDs list, an expected security monitoring event data collection mode, an expected target reporting type (e.g., identifying various elements where security event data is expected to be collected), and security evaluation and monitoring services.

The NRF 218, upon receiving a token request from NF service consumers 302, verifies the enhanced NF profiles of both the NF service consumer 302 and the target NF service producer. Based on this verification, the NRF 218 generates and issues an enhanced token to enable fine-grained access authorization, allowing for security event data exposure related claims verification by the NF service producers during the access service request phase. The NRF 218 verifies the input parameters and performs additional checks using the enhanced NF profile. These checks include verifying the expected security event data exposure services, NF types, security event IDs, and authorization for specific OSFs. If the verification is successful, the NRF generates an enhanced token with corresponding claims, including information about the security event data exposure services, authorized security event IDs, and consumer details. For example, enhanced token claims may include, but are not limited to, one or more of authorized security monitoring event data collection, notification, or exposure services and operations, authorized security event data exposure services and operations, authorized security event IDs, an OSF ID (e.g., as source service consumer), and data collection function IDs as authorized service consumers (e.g., as an intermediate service consumer, as applicable).

At 308, the NRF 218 verifies that the input parameters NF instance ID, NF type, and PLMN IDs if available in the token request match with the corresponding ones in a public key certificate of the NF service consumer 302 or those in the NF profile of the NF service consumer 302. If security event data exposure service is expected, then the NRF 218 performs additional verifications using the enhanced NF profile. These verifications include, but are not limited to, checking if the expected security event data exposure services match those in the NF profile of the NF service consumer 302, verifying the NF type as a security event data collection network function, or checking if an existing NF (e.g., data collection function, NWDAF, MFAF, NEF) includes security event data exposure services in NFServices or NFServicesList, confirming that the expected list of security event IDs matches those in the NF profile, and ensuring that the data collection function that is eligible to notify the OSF identified with OSF information as a source NF service consumer (e.g., where the data collection function acts as an intermediate NF service consumer) matches the authorized OSF information (e.g., ID, FQDN, address) in the NF profile of the NF service consumer 302.

The NRF 218 also verifies if the expected security event data exposure services in the token request match the allowed services in the NF profile of the NF service producer, checks if security event data logging and exposure feature support is available as per the NF profile of the NF service producer and if the expected security event IDs received in the token match the authorized security event IDs list present in the NF profile of the NF service producer, and confirms if the NF type (e.g., and also data collection function information, including ID, FQDN, address) of the NF service consumer 302 matches the authorized or expected data collection function type (e.g., NWDAF, data collection coordination function (DCCF), MFAF, or any designated data collection network function or agent in the network) in the NF profile of the NF service producer for security event data exposure service. Additionally, or alternatively, the NRF 218 verifies if the data collection function is authorized to collect and notify and/or provide security event data to a defined OSF based on the NF profile of the service producer, as the NF profile of the service producer includes an authorized security event data collection mode (e.g., direct by OSF or indirect by OSF via a data collected function). Further, the NRF 218 verifies if the data collection function is eligible or authorized to notify the defined OSF identified with OSF information (e.g., NF service indirect and/or secondary consumer) matches the authorized OSF information (e.g., ID, FQDN, address) to receive the security event data at the OSF to perform security evaluation and monitoring.

The NF profiles of both the NF service consumer 302 and the NF service producer may include additional parameters and/or IEs to support the verifications, such as expected and authorized security event data exposure services, security event IDs, and authorized consumer OSF information. If any of the verifications fail, then the token request is not processed further. The NRF 218 may also verify S-NSSAIs and check for slice-based restrictions on accessing services of NF service producers. For example, the NRF 218 may verify the S-NSSAIs of the NF service consumer 302 to check whether the NF service consumer 302 is authorized to access services of the NF service producers of a defined NF type depending on the slices for which they offer their services. The NRF 218 checks whether the NF service consumer 302 is authorized to access the requested services. For example, the NRF 218 may verify that the NF service consumer 302 may serve a slice, which is included in the authorized slices for the NF service producer of a specific NF type. If the NF service consumer 302 (e.g., a data collection function) is authorized, then the NRF 218 generates an enhanced token with corresponding claims. The NRF 218 digitally signs the generated token based on a shared secret or private key. If the NF service consumer 302 is not authorized, then the NRF 218 does not issue a token to the NF service consumer 302.

The claims in the token may include, but are not limited to, the NF instance ID of the NRF 218 (e.g., the issuer), an NF instance ID of the NF service consumer 302 (e.g., subject), where this IE includes the NF instance ID of a data collection function as an intermediate consumer and/or the authorized OSF identification information (e.g., OSF ID, address, FQDN as the primary consumer), NF type of the NF service producer (e.g., audience), one or more expected service names, including security event data exposure services as authorized services (e.g., scope), expiration time (e.g., expiration) and additional scope information (e.g., authorized resources and authorized actions, or service operations, on the resources). In some cases, such as for security event data exposure services, additional scope or a dedicated claim may also include authorized security event IDs, an intermediate consumer as a data collection function, and a consumer as an OSF ID, address, and/or FQDN (e.g., for NF instance ID of NF service consumer 302 and/or source NF instance ID does not include the information). The claims may include a list of S-NSSAIs or NSI IDs for the expected NF service producer instances. The claims may include the NF set ID and/or NF service set ID of the expected NF service producer instances. If the claims do not include a list of NSSAIs or NSI IDs for the target NF type, then the token may be used to access expected NF services of expected NF service producers of the NF type based on local configuration and operator policy.

For security event data exposure services, the scope and/or additional scope includes the security event data exposure services and/or operation level scopes, as well as the authorized OSF identification information. Additionally, or alternatively, for security event data exposure services, the additional scope or a dedicated claim may also include one or more authorized security event IDs, an intermediate consumer as a security event data collection agent and/or function, and a source consumer as an OSF ID, address, or FQDN, if the NF instance ID or source instance ID of an NF service consumer 302 does not include the information in the earlier claims. For security event data exposure services, the source may include an intermediate consumer as a security event data collection agent and/or function, and a source consumer as an OSF ID, address, or FQDN, if the NF Instance ID or source instance ID of the NF service consumer 302 does not include the information. In some examples, the claim may include security event IDs if the producer (e.g., an NF, AF, or RAN function) supports a security event data exposure service and a service consumer requested token to be used for security event data exposure services. The security event IDs may include security event IDs that the consumer is authorized to access. In some examples, the claim may include source OSF IDs if the NRF 218 supports providing an OSF ID of the source OSF in the token claims (e.g., if the token request is from the data collection function as the NF service consumer 302 requests data from NF service producers on behalf of the source OSF). In some other examples, the claim may include source OSF IDs if the NRF 218 supports providing an OSF ID of the source OSF in the token claims (e.g., if the token request is from the OSF or any data collection function residing at the OSF as an NF service consumer 302 requests data from NF service producers on behalf of the source OSF).

If the authorization is successful, then the NRF 218 sends the token to the NF service consumer 302 in the Nnrf_AccessToken_Get response operation, where the additional claims in the token include one or more security event data exposure services as authorized services, an intermediate consumer data collection function (e.g., name, ID, type), a consumer OSF (e.g., ID, address, FQDN as a source), and one or more authorized security event IDs. Otherwise, the NRF 218 sends an error response (e.g., Oauth 2.0 error response). The NF service consumer 302 may store the received tokens. Stored tokens may be reused for accessing services from a NF service producer of the NF type listed in the claims (e.g., scope, audience) during a validity time of the tokens.

In some cases, the NRF 218 may perform an authentication of an OSF before issuing a token to the data collection function. The data collection function may indicate a source consumer as an OSF and may include a CCA token for the OSF (e.g., received from OSF). Additionally, or alternatively, if a CCA token of an OSF (e.g., CCA_OSF) is present in the token request from the data collection function, then the NRF 218 may verify the CCA_OSF and check if the received OSF ID in the token request matches the subject claim in the CCA token or the OSF ID in the public key certificate of the OSF. A receiving node (e.g., the NRF 218) performs the verification of the CCA_OSF. For example, the NRF 218 validates a signature of the JavaScript Object Notation web signature (JWS) of the CCA token. The NRF 218 validates a timestamp and/or an expiration time of the CCA token. The NRF 218 checks that the audience claim in the CCA token matches a type. The NRF 218 verifies that the OSF ID of the NF consumer in the CCA token matches the subject (e.g., OSF ID or NF instance ID in the public key certificate used for signing the CCA token).

To perform security evaluation and monitoring, the operator may deploy a security function (e.g., an OSF). The security function that performs the security evaluation and monitoring resides in the operator's domain (e.g., external to the network, fully or part of the functionalities may be internal to the network), and the security function is considered as a trusted entity. The security function and application logic of the security function are up to implementation by the operator. The NF service producer registration in the NRF 218 (e.g., using enhanced NF profile information) may include resource server (e.g., NF service producer) registration with the authorization server (e.g., NRF 218). An NF service registration procedure is used to register the resource server (e.g., NF service producer) with the authorization server (e.g., NRF 218). The NF service producer, as part of an NF profile of the NF service producer (e.g., including IEs listed in the enhanced NF profile), may include additional scope information related to the authorized service operations (e.g., including security event exposure services and/or security monitoring event data collection, exposure, and/or notification services) and resources per NF service consumer type.

The NF service producer registers as a resource server in the NRF 218 (e.g., an OAuth 2.0 resource server). The NF profile configuration data (e.g., including IEs listed in the enhanced NF profile) of the NF service producer may include the additional scope. The additional scope information indicates the resources and the actions (e.g., service operations including security event exposure services and/or security monitoring event data collection, exposure, and/or notification services) that are authorized on the resources for the NF service consumer 302. The resources may be per NF type of the NF service consumer 302 or per NF instance ID of the NF service consumer 302. After storing the NF profile (e.g., including IEs listed in the enhanced NF profile), the NRF 218 responds with a message that indicates success.

After successful authentication between the NRF 218 and an NF, the NRF 218 determines whether the NF is authorized to perform discovery and registration. The NF service consumer 302 attempts to discover services available at the network based on a service name (e.g., security monitoring event data collection and/or notification services and/or security event data exposure services) and a target NF type (e.g., data collection function and/or any core NF based on a target of event reporting information). The NF service consumer 302 invokes a request for NF discovery (e.g., Nnrf_NFDiscovery_Request). The request may include, but is not limited to, an expected NF service name (e.g., security monitoring event data collection and/or notification services and/or security event data exposure services), an NF type of the expected NF instance (e.g., data collection function and/or any core NF based on the target of event reporting information), and an NF type of the NF consumer (e.g., OSF or data collection function) from an appropriate configured NRF 218 in a same PLMN. Additionally, or alternatively, the request may include a producer NF set ID, an NF service set ID, a subscription permanent ID (SUPI), one or more data set IDs, an external group ID (e.g., for UDM, unified data repository (UDR) discovery), a UE routing indicator and home network public key ID (e.g., for UDM and AUSF discovery), an S-NSSAI, an NSI ID if available, and other service-related parameters (e.g., one or more expected security event IDs for an OSF or a data collection function). Additionally, or alternatively, for AMF discovery, the request may include an AMF region ID, an AMF set ID, and/or a tracking area identity (TAI). The NF service consumer 302 may indicate a preference for a target NF location in the request.

The NRF 218 authorizes the request. For example, the NRF 218 determines whether the NF service consumer 302 is authorized to discover the expected NF instances based on the profile (e.g., enhanced NF profile information) of the expected NF and/or NF service and the type of the NF service consumer 302. If authorized, then the NRF 218 determines a set of NF instances matching the request and internal policies of the NRF 218. The NRF 218 and sends the NF profiles of the determined NF instances, where each NF profile includes at least the output parameters to the NF service consumer 302. For example, the NRF 218 may send a response message to the discovery request message (e.g., an Nnrf_NFDiscovery_Request response message). If the target NF is a data collection function, if expected services includes security monitoring event data collection and/or notification services, and if security event IDs are listed, then the NRF 218 returns applicable NF instances of a data collection function that offers security monitoring event data collection and/or notification services for the defined security event IDs (e.g., if authorized based on the NF profile information of the data collection function).

If a target of reporting information is received in a discovery request, then the NRF 218 checks if the OSF is authorized to discover, use, and/or consume security monitoring event data collection and/or notification services of data collection function based on the NF profile of the OSF. If the target NF is any NF in the network data collection function, if expected services includes security event data exposure services, and if security event IDs are listed, then the NRF 218 returns applicable NF instances that support security event exposure services and/or features and specified security event IDs (e.g., if authorized based on the NF profile information as per enhanced NF profile information). If a target of reporting information is received in discovery request, then the NRF 218 checks if the data collection function is authorized to discover, use, and/or consume security event data exposure services of target NFs based on the NF profile of the data collection function.

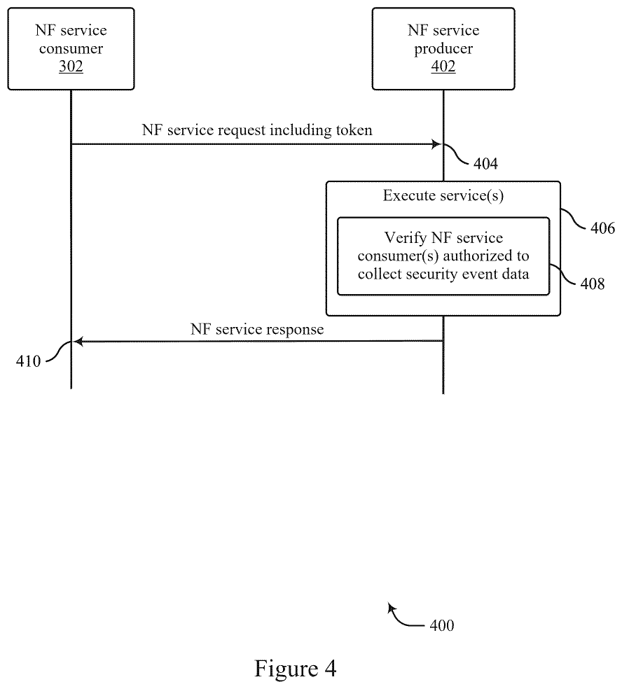

FIG. 4 illustrates an example of a signaling diagram 400 in accordance with aspects of the present disclosure. In some examples, the signaling diagram 400 may implement aspects of the wireless communications system 100, the SBA diagram 200, and the signaling diagram 300. The signaling diagram 400 may illustrate an example of an NF service consumer 302 and an NF service producer 402 implementing authorization for security event data collection in a wireless communications system, where the NF service consumer 302 may be an example of an NF service consumer 302 as described with reference to FIG. 3. Alternative examples of the following may be implemented, where some processes are performed in a different order than described or are not performed. In some cases, processes may include additional features not mentioned below, or further processes may be added.

In some examples, the NF service consumer 302 may be an example of one or more OSFs. In some other examples, the NF service consumer 302 may be an example of one or more data collection functions. Although a single (e.g., one) NF service consumer 302 is illustrated, any numerical quantity of NF service consumers may implement authorization for security event data collection. The NF service producer 402 may be an example of any NF in a CN (e.g., a CN 106, as described with reference to FIG. 1), an AF, or any other function. Although a single NF service producer 402 is illustrated, any numerical quantity of NF service producers may implement authorization for security event data collection.

In some examples, the NF service consumer 302 and/or the NF service producer 402 may implement the enhanced NF profiles and/or enhanced token claims to perform authorization for security event data collection, as described with reference to FIG. 3.

At 404, an NF service consumer 302 transmits an NF service request that includes a token to an NF service producer 402. For example, the NF service consumer 302 transmits a message to the NF service producer 402 that includes a token with additional claims, including, but not limited to, security event data exposure as authorized services, a consumer OSF ID, address, or FQDN, one or more security event IDs, source OSF identification information, and a CCA token of an OSF, among other examples. The NF service request may be an example of a security event data exposure service request.

At 406, the NF service producer 402 executes one or more services. For example, at 408, the NF service producer 402 verifies one or more NF service consumers 302 are authorized to collect security event data. The NF service producer 402 verifies the integrity and claims in the token (e.g., one or more allowed security event IDs, one or more security event data exposure services, an authorized security event data collection function ID, and/or an authorized source OSF ID, among others). If the NF service consumers 302 are authorized to collect the security event data, then the NF service producer 402 executes the services. If the NF service consumers 302 are not authorized to collect the security event data, then the NF service producer 402 transmits an error message (e.g., to the NF service consumer 302 and/or to another NF).

At 410, the NF service producer 402 transmits an NF service response to the NF service consumer 302. The response may include the security event data for collection, exposure, and/or notification.

Prior to the NF service request, the NF service consumer 302 may perform a discovery operation (e.g., via an Nnrf_NFDiscovery_Request) with the additional scopes (e.g., specific to expected security event data exposure service and security event IDs) to select an NF service producer 402 (e.g., resource server) that is able to authorize the service access request, as described with reference to FIG. 3. The NF service consumer 302 (e.g., a data collection function) may be in possession of a valid token (e.g., the enhanced token is obtained by the data collection function from the NRF) before requesting service access from the NF service producer 402.

Then, at 404, the NF service consumer 302 (e.g., a data collection function) requests service from the NF service producer 402. The NF service consumer 302 includes the token in the request, where new additional claims in the token include security event data exposure services as authorized services, an intermediate consumer as a data collection function (e.g., name, ID, type), a consumer as an OSF ID, address, FQDN (e.g., as a source), one or more authorized security event IDs, and may also include OSF identification information (e.g., the OSF ID, address, FQDN) based on a local operator configuration as a source consumer of the requested security event data. In some cases, the NF service request may include a CCA token for the OSF (e.g., CCA_OSF).

The NF service consumer 302 and NF service producer 402 may authenticate each other (e.g., based on TLS or IPSec or CCA). For example a service request may be related to a security event exposure subscribe and/or unsubscribe. For security event data collection (e.g., for security evaluation and monitoring to be done by the OSF), a data collection function subscribes to or may cancel subscription for one or more security event IDs by invoking a subscribe or unsubscribe operation, respectively. The subscribe operation may include an Nnf_SecurityEventExposure_Subscribe operation, while an unsubscribe operation may include an Nnf_SecurityEventExposure_Unsubscribe operation. Additionally, or alternatively, the OSF authorization verification by an NF service producer 402 is based on an operator configuration and by verifying the related claims in the token. For example, the NF service producer 402 verifies a data collection function includes OSF identification information (e.g., OSF ID, address, FQDN) based on the local operator configuration, to indicate the NF service producer that OSF is the source consumer of the requested security event data. The NF service producer 402 verifies the received OSF ID matches an authorized OSF ID as a source consumer for security event data in the NF profile or a local configuration or matches the received token claims at the NF service provider 402.

In some examples, the NF service producer 402 verifies the token. For example, the NF service producer 402 ensures the integrity of the token by verifying the signature using a public key of an NRF or checking a MAC value using a shared secret. If the integrity check is successful, then the NF service producer 402 verifies the claims (e.g., authorized security event IDs, authorized security event data exposure services, authorized data collection function ID, authorized source OSF ID) in the token. For direct communication between an NF service consumer 302 and an NF service producer 402, the NF service producer 402 checks that the NF instance ID (e.g., related to the data collect function, including a security event data collect function ID) in the subject claim within the token matches the NF instance ID in a TLS client certificate of the NF service consumer 302 (e.g., in the subjectAltName parameter). The NF service producer 402 checks that the audience claim in the token matches an identity of the NF service producer 402 or the type of NF service producer 402. If a list of S-NSSAIs or list of NSI IDs is present, then the NF service producer 402 checks that the NF service producer 402 serves the corresponding slices. When the NF service request is for information related to a specific UE, the NF service producer 402 may check that the NF service consumer 302 is authorized to access (e.g., as indicated by the S-NSSAIs of the NF service producer 402 in the token presented by the NF service consumer 302) at least one of the slices that the UE is currently registered to. For example, the NF service producer 402 verifies that the authorized NSSAIs of the UE intersect with the S-NSSAIs of the NF service producer 402 in the token.

If an NF set ID present, then the NF service producer 402 shall check the NF set ID in the claim matches its own NF set ID. If an NF Service set ID present, then the NF service producer 402 checks if the NF service consumer 302 is authorized to access the requested service according to NF service producer 402 service set ID in the token claim. If scope is present, then the NF service producer 402 checks that the scope matches the requested service operation. For security event data exposure services, the NF service producer 402 verifies the scope and/or the additional scope or a dedicated claim. For example, the NF service producer 402 verifies if an NF service consumer 302 (e.g., a data collection function) is authorized to request exposure of security event data related to the security event IDs according to the authorized security event IDs in the token claims. Additionally, or alternatively, the NF service producer 402 verifies if the data collection function is authorized to collect the exposed security event data as an intermediate consumer and if the data collection function is authorized to provide and/or notify the exposed and collected security events or security event data to a defined source consumer (e.g., a defined OSF ID, address, FQDN) according to the scope and/or additional scope source or a dedicated claim that indicates the security event data collection ID and the OSF identification information. If the token includes additional scope information (e.g., authorized resources and authorized actions, including service operations related to the authorized security event data collected services, on the resources), then the NF service producer 402 checks that the additional scope matches the requested service operation. The NF service producer 402 checks that the token has not expired by verifying the expiration time in the token against the current data and/or time.

If the CCA token for data collection function is present in the service request, then the NF service producer 402 may verify that the CCA token and that the subject claim (e.g., the NF instance ID of the NF service consumer 302) in the token matches the subject claim in the CCA token. If a CCA token of an OSF (e.g., CCA_OSF) is present in the service request, then the NF service producer 402 may verify the CCA token and that the OSF ID claim in the token matches the subject claim in the CCA token. The verification of the CCA token is performed by a receiving node (e.g., an NF service producer 402). For example, the NF service producer 402 validates the signature of the JWS. The NF service producer 402 validates the timestamp and/or the expiration time. The NF service producer 402 checks that an audience claim in the CCA token matches a type of the NF service producer 402. The NF service producer 402 verifies that the OSF ID of the NF consumer in the CCA token matches the OSF ID and/or NF instance ID in the public key certificate used for signing the CCA token.

If the verification is successful, then the NF service producer 402 executes the requested service and responds back to the NF service consumer 302. Otherwise, the NF service producer 402 replies with an error response (e.g., based on Oauth 2.0 error response). For example, if the NF service request is related to a security event exposure subscribe, unsubscribe, data request and a data collection function subscribes to one or more security event IDs, then the NFs notify the data collection function (e.g., with the security event report) by invoking a notify service operation (e.g., an Nnf_SecurityEventExposure_Notify service operation) according to the security event reporting information in the subscription. The data collection function may send a security event report to the OSF that indicates one or more security events identified from the security event data and/or the security event data.

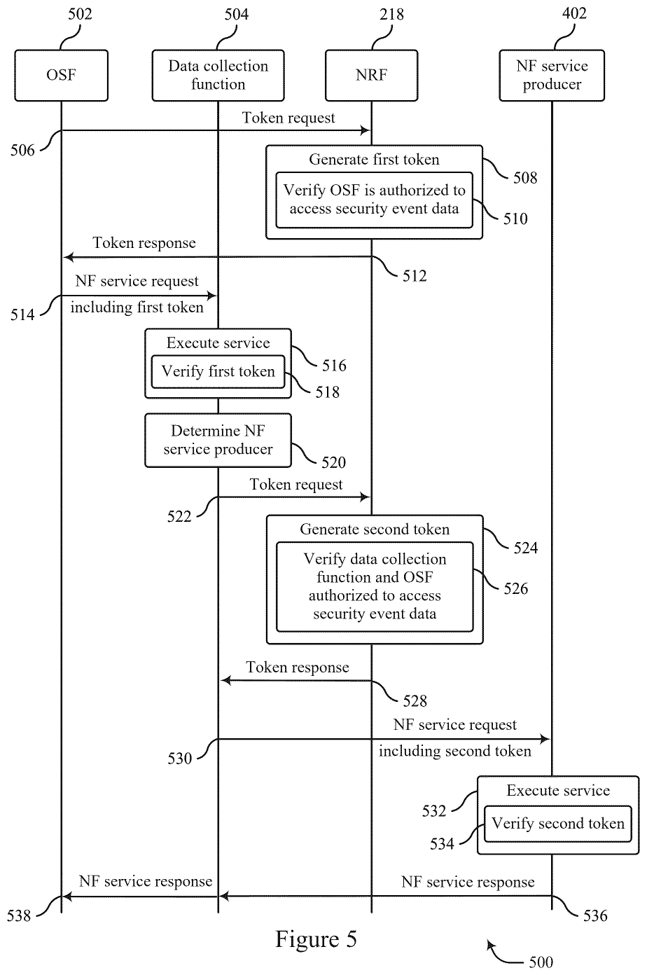

FIG. 5 illustrates an example of a signaling diagram 500 in accordance with aspects of the present disclosure. In some examples, the signaling diagram 500 may implement aspects of the wireless communications system 100, the SBA diagram 200, the signaling diagram 300, and the signaling diagram 400. The signaling diagram 500 may illustrate an example of an OSF 502, a data collection function 504, an NRF 218, and an NF service producer 402 implementing token generation and authorization for security event data collection in a wireless communications system, where the OSF 502 and the data collection function 504 may be examples of an NF service consumer 302 as described with reference to FIG. 3. The NRF 218 may be an example of an NRF 218 as described with reference to FIGS. 2 and 3. The NF service producer 402 may be an example of an NF service producer 402, as described with reference to FIG. 4. Alternative examples of the following may be implemented, where some processes are performed in a different order than described or are not performed. In some cases, processes may include additional features not mentioned below, or further processes may be added.

Although a single (e.g., one) OSF 502 and data collection function 504 is illustrated, any numerical quantity of NF service consumers may implement authorization for security event data collection. The NF service producer 402 may be an example of any NF in a CN (e.g., a CN 106, as described with reference to FIG. 1), an AF, or any other function. Although a single NF service producer 402 is illustrated, any numerical quantity of NF service producers may implement authorization for security event data collection.

In some examples, the OSF 502, the 504, the NRF 218, and the NF service producer 402 may implement the enhanced NF profiles and/or enhanced token claims to perform authorization for security event data collection, as described with reference to FIG. 3.

At 506, the OSF 502 transmits a token request to the NRF 218. For example, the OSF 502 transmits an Nnrf_AccessToken_Get request message to the NRF 218. The message may include, but is not limited to, one or more expected NF service names (e.g., expected security monitoring event data exposure services), an NF type (e.g., data collection function and/or agent type), a source NF (e.g., an OSF and/or other security event data consumer), and target event reporting information, among other parameters.

At 508, the NRF 218 generates a first token. For example, at 510 the NRF 218 verifies the OSF 502 is authorized to access security event data.

At 512, the NRF 218 transmits a token response to the OSF 502. The token response includes the first token. For example, the NRF 218 transmits an Nnrf_AccessToken_Get response message to the OSF 502. The message may include, but is not limited to, a parameter that indicates when the first token expires (e.g., expires_in) and a parameter that indicates the first token (e.g., access_token_OSF or access_token_security_event_data_consumer).

In some examples, the OSF 502 is a security event data consumer (e.g., an NF service consumer) and sends a request to the NRF 218 to receive a first token. The OSF 502 uses the first token to request services of an OSF 502, to be used for security monitoring event data collection, exposure, and/or notification. The token request can include one or more expected NF service names (e.g., security monitoring event data exposure services), an and NF type (e.g., data collection function 504), source NF (e.g., an OSF 502 and/or other security event data consumer) identification information, and a target of the event reporting. The NRF verifies the OSF 502 is authorized to access the security event data and generates the first token (e.g., access_token_OSF with additional claims) and sends the first token to the NF service consumer (e.g., the OSF 502). The target of the event reporting information indicates the objects for which data is requested to enable analysis and monitoring, entities such as specific UEs, a group of UEs or any UE (e.g., all UEs), NFs, AFs, RAN nodes, etc. For a CN or an SBA, a target of event reporting includes NF types, NF IDs, NF instance IDs, etc.

The claims in the access_token_OSF may include the NF instance ID of an NRF 218 (e.g., the issuer), an NF instance ID of the NF service consumer (e.g., subject) (e.g., the OSF ID identification information, including OSF ID, address, or FQDN), an NF type of the NF service producer (e.g., audience, including a data collection function 504), expected service names, including security monitoring event data collection and/or exposure services as authorized services (e.g., scope), expiration time (e.g., expiration), and optionally additional scope information authorized resources and authorized actions (e.g., service operations) on the resources. For security monitoring event data collection and/or exposure services, additional scope or a dedicated claim may include authorized security event IDs. The claims may include a list of S-NSSAIs or NSI IDs for the expected NF service producer instances. The claims may include the NF set ID and/or NF service set ID of the expected NF service producer instances.

Target of event reporting information may additionally, or alternatively, be referred to as target of external analytics reporting or monitoring information or target of event reporting external ID. Security monitoring event data exposure service may additionally, or alternatively, be referred to as security monitoring event data collection service or security monitoring event data collection and/or notification service. If the OSF 502 expects one or more security monitoring event data exposure services from the data collection function 504, then the NRF 218 verifies the NF profile of the OSF 502 and the NF profile of the data collection function 504. For example, the NRF 218 verifies the NF profile if the expected security monitoring event data exposure services received in the token request match the authorized and/or expected security monitoring event data exposure services in the NF profile of the data collection function 504 (e.g., for data collection and notification). If the NF type indicates the data collection function 504 or if the NF is an existing NF (e.g., DCCF, NWDAF, MFAF, NEF), then the NRF 218 verifies the NF profile by confirming the expected NFServices or NFServicesList including expected security monitoring event data exposure services in the NF profile of the OSF 502 (e.g., security monitoring event data collection and/or notification services) match the NF profile of the NF service consumer (e.g., the OSF 502). Additionally, or alternatively, the expected list of security event IDs may be included in the token request at 506, and the NRF 218 verifies if the expected list of security event IDs matches the authorized security event IDs in the NF profile of the NF service producer (e.g., data collection function 504) for data collection from other NFs.

The NRF 218 verifies if the OSF 502 is eligible to request a security monitoring event data collection and/or exposure service from a data collection function 504 or verifies if the data collection function 504 is eligible and/or authorized to notify the OSF 502 identified by confirming the OSF information (e.g., as an NF service indirect and/or secondary consumer) matches the authorized OSF information (e.g., ID, FQDN, address) in the NF profile of an NF service producer (e.g., the data collection function 504 for data notification). The NRF 218 verifies if the target of event reporting received in the token request matches the authorized target of event reporting (e.g., for the OSF 502) based security evaluation and monitoring in the NF profile of the NF service producer (e.g., the data collection function 504 for data collection and notification). The NRF 218 verifies if an expected NF type and/or data collection function information (e.g., ID, FQDN, address) matches the NF type and/or data collection function information of the authorized and/or expected data collection function 504 (e.g., security event data collection function, NWDAF, DCCF, MFAF, or any designated data collection network function or agent in the network) in the NF profile of the NF service consumer (e.g., the OSF 502 for security monitoring event data exposure service). The NRF 218 verifies if the data collection function 504 is authorized to collect security event data to notify and/or provide to an OSF 502 based on an NF profile of the OSF 502, as the NF profile of the OSF 502 includes authorized security event data collection mode direct (e.g., by the OSF 502) or indirect (e.g., by the OSF 502 via a data collection function 504). The NRF 218 verifies if the data collection function 504 is eligible or authorized to notify the OSF 502 identified with the OSF information (e.g., as an NF service indirect or secondary consumer) if the OSF information matches the authorized OSF information (e.g., ID, FQDN, address) to receive the security event data at the OSF 502 to perform security evaluation and monitoring.

The NF profile of the OSF 502 includes, but is not limited to, parameters (e.g., IEs) that indicate one or more of expected security monitoring event data exposure services, expected security event IDs for data collection, target event reporting information, expected NF type as data collection function 504, authorized security event data collection mode direct (e.g., by the OSF 502) or indirect (e.g., by the OSF 502 via a data collection function 504), and security monitoring event data collection authorized (e.g., allowed, permitted) or not for the OSF 502. The NF profile of the data collection function 504 includes, but is not limited to, parameters (e.g., IEs) that indicate one or more of authorized security monitoring event data exposure services, authorized list of security event IDs for data collection and exposure or re-exposure, expected or authorized (e.g., allowed, permitted) consumer OSF ID, address, or FQDN to notify for security evaluation and monitoring purpose, and authorized UEs, RAN IDs, NF IDs, and/or NF instance IDs for security event data collection.

At 514, the OSF 502 transmits an NF service request to the data collection function 504 that includes the first token. For example, the OSF 502 transmits a message that includes, but is not limited to, parameters that indicate one or more security event IDs, target event reporting information, the first token, and a CCA token for the OSF 502 and/or the security event data consumer. The NF service consumer (e.g., the OSF 502) initiates an NF service request to the data collection function 504 that includes the security event IDs, target event reporting information, and the access_token_OSF (e.g., also referred to as token_security event data consumer). The NF service consumer generates a CCA token (e.g., CCA_OSF) and includes the CCA token in the request message to authenticate the OSF 502 to one or more NF service producers, such as the NRF 218 and the data collection function 504.

The CCA token is a token signed by the NF service consumer. The CCA token enables the NF service consumer to authenticate towards the receiving end point (e.g., NRF 218, NF service producer 402) by including the signed token in a service request. The CCA token includes an NF instance ID (e.g., OSF ID) of the NF service consumer that can be checked against the certificate by the NF service producer. The CCA token includes a timestamp as basis for restriction of a lifetime. CCA tokens are expected to have a shorter lifetime than tokens generated by the NRF 218 so the CCA tokens can be used for NF to NF communication. If the lifetime of the CCA token is less than a threshold value, then the NF service consumer generates a new CCA token for respective new service requests. CCA tokens may be JSON web tokens and are secured with digital signatures based on JWS.

A CCA token may include, but is not limited to, the OSF ID as an NF instance ID of the NF service consumer (e.g., a subject), a timestamp and an expiration time, and an NF type of the expected audience (e.g., an audience). The NF type of the expected audience may include the type of the NRF 218 and/or the NF type of the NF service producer (e.g., a data collection function 504 related to security monitoring event data exposure service in the case of security monitoring and evaluation). The NF service consumer (e.g., the OSF 502) digitally signs the generated CCA token based on a private key of the NF service consumer. The signed CCA token includes one or more of an X.509 URL (x5u) to refer to a resource for the X.509 public key certificate or certificate chain used for signing the CCA token or the X.509 certificate chain (x5c) include the X.509 public key certificate or certificate chain used for signing the CCA token.

The verification of the CCA token of the OSF 502 may be performed by a receiving node (e.g., an NRF 218 or the NF service producer). For example, the receiving node validates the signature of the JWS and validates the timestamp and/or the expiration time. If the receiving node is the NRF 218, then the NRF validates the timestamp and the expiration time. If the receiving node is the NF service producer (e.g., data collection function 504), then the NF service producer validates the expiration time and may validate the timestamp. The receiving node checks that the audience claim in the CCA token matches a type of the receiving node. The receiving node verifies that the NF instance ID (e.g., OSF ID) of the NF consumer in the CCA token matches the NF instance ID (e.g., OSF ID) in the public key certificate used for signing the CCA token.

At 516, the data collection function 504 executes the service. For example, at 518 the data collection function 504 verifies the first token and then determines to execute the service, accordingly. The data collection function 504 verifies if the access_token_OSF is valid and executes the service. If the NRF 218 does not support authorization of the source NF (e.g., the OSF 502) for data access via the data collection function 504, then the data collection function 504 authorizes the data access of the NF service consumer. The data collection function 504 verifies the access_token_OSF if the requested security monitoring event data exposure services received (e.g., service request) matches the expected security monitoring event data exposure services according to the authorized token claims, if a requested list of security event IDs matches the authorized list of security event IDs in the token claims, if the target of event reporting requested matches the authorized target of event reporting (e.g., for OSF based security evaluation and monitoring) in the token claims, if the OSF 502 is eligible to request security monitoring event data collection service from data collection function 504 or if the data collection function is eligible and/or authorized to notify the OSF 502 identified with OSF information (as NF service indirect or secondary consumer) matches the authorized OSF information (e.g., ID, FQDN, address) in the token claims.

At 520, the data collection function 504 determines one or more NF service producers 402. The data collection function 504 determines the NF service producers 402 from where the data is to be collected and by taking into account the target of event reporting. If the NF service consumer sends the NF service producer information (e.g., NF service producer type and instance ID) with the service request at 514, then the data collection function 504 does not determine the NF service producer 402 and requests a token from the NRF 218 using the NF service producer 402 details sent by the NF service consumer.

At 522, the data collection function 504 transmits a token request to the NRF 218. For example, the data collection function 504 transmits a Nnrf_AccessToken_Get request message to the NRF 218 that includes one or more parameters. The parameters include, but are not limited to, one or more expected NF service names (e.g., security event data exposure services), an NF type (e.g., a data producer NF, and a source NF, including the OSF 502 and/or the data collection function 504), and one or more CCA tokens for the source NF. The data collection function 504 sends an Nnrf_AccessToken_Get request to the NRF 218 including the information to identify the target NF (e.g., one or more NF service producers 402), expected NF service names as security monitoring event data exposure services, and NF type (e.g., data or service producer NF, the source NF as the NF service consumer, including the data collection function 504 and the OSF 502), the NF instance ID of the data collection function 504, and the CCA_OSF provided by the NF service consumer with the CCA token of the data collect function 504. The nfInstanceID IE attribute in the token request (e.g., Nnrf_AccessToken_Get) indicates the NF instance ID of the data collection function 504 as an intermediate NF service consumer, whereas the sourceNfInstanceID IE attribute indicates the NF instance ID of the source (e.g., OSF ID, NF service consumer, the OSF 502).

At 524, the NRF 218 generates a second token. For example, at 526, the NRF 218 verifies the data collection function 504 and the OSF 502 are authorized to access the security event data. If the data collection function 504 and the OSF 502 are authorized, then the NRF 218 generates the second token (e.g., access_token_data producer). The NRF 218 checks whether the data collection function 504 and the NF service consumer (e.g., the OSF 502) are authorized to access the service provided by the identified NF service producers 402 and the data collection function 504 as the proxy is authorized to request the service from the identified NF service producers 402 on behalf the NF service consumer. The NRF 218 authenticates both the data collection function 504 and the OSF 502 based on an SBA method.

At 528, the NRF 218 transmits a token response to the data collection function 504. The token response includes the second token. For example, the NRF 218 transmits an Nnrf_AccessToken_Get response message to the data collection function 504 that includes a parameter that indicates when the second token expires (e.g., expires_in) and a parameter that indicates the second token (e.g., access_token_data producer). After successful verification, the NRF 218 generates and provides a second token (e.g., access_token_data producer) to the data collection function 504, as well as enhancements proposed with an NF instance ID of the data collection function 504 (e.g., subject) and an additional token claim. The additional token claim includes the identity of the source NF service consumer as an OSF ID to authorize both the data collection function 504 and the NF service consumer (e.g., the OSF 502) to consume the services of one or more NF service producers 402.

The claims in the second token include the NF instance ID of the NRF 218 (e.g., issuer), the NF instance ID of the NF service consumer (e.g., subject), including the NF instance ID of the data collection function 504 as an intermediate NF service consumer and/or the authorized OSF identification information (e.g., OSF ID, address, or FQDN) as the primary or source NF service consumer for security event data exposure services access authorization, the NF type of the NF service producer (e.g., audience), the expected service names (e.g., security monitoring event data collection and/or exposure services as authorized services, referred to as scope), the expiration time (e.g., expiration), and optionally additional scope information that includes authorized resources and authorized actions (e.g., service operations) on the resources. For security monitoring event data collection and/or exposure services, additional scope or a dedicated claim may also include authorized security event IDs, intermediate consumer as the data collection function 504, and the consumer as OSF ID, address, or FQDN (e.g., where the NF instance ID of the NF service consumer or the source NF instance ID does not include the information). The claims may include a list of S-NSSAIs or NSI IDs for the expected NF service producer instances. The claims may include the NF set ID and/or NF service set ID of the expected NF service producer instances.

At 530, the data collection function 504 transmits an NF service request to the NF service producer 402 that includes the second token. For example, the data collection function 504 transmits a message that includes, but is not limited to, parameters that indicate the second token and a CCA token for the data collection function 504, as well as a CCA token for the OSF 502 and/or the security event data consumer. The data collection function 504 requests service from one or more NF service producers 402. The request includes the content of the CCA token of the OSF 502 (e.g., CCA_OSF) and the content of the CCA token of the data collection function 504 (e.g., CCA_data collection function/agent), so that the NF service producers 402 authenticate the NF service consumer (e.g., the OSF 502 and the data collection function 504). For example, the NF service producers 402 check the subject claim of the CCA_OSF with the token claim conveying the source NF instance ID, when the claim is present in the token.

At 532, the NF service producer 402 executes the service. For example, at 534 the NF service producer 402 verifies the second token and executes the requested service. In some cases, one or more NF service producers 402 authenticate the NF service consumer (e.g., the OSF 502) and the intermediate service consumer (e.g., the data collection function 504) and ensure the source NF service consumer identity is included as a claim in the second token. The NF service producers 402 authenticate and authorize the data collection function 504, and after authentication and authorization is successful, the NF service producers 402 execute the service.

At 536 and at 538, the NF service producer 402 transmits an NF service response to the data collection function 504, and the data collection function 504 transmits the NF service response to the OSF 502, respectively. The NF service responses include the security event data. One or more NF service producers 402 provide the requested security event data to the data collection function 504. The data collection function 504 forwards the received security event data to one or more NF service consumers (e.g., the OSF 502).

In some examples, such as if an additional NF service consumer (e.g., another OSF) requests the data after one or more of the requests and/or token generation in the signaling diagram 500 is already performed, then the additional NF service consumer can perform 506 through 530. When the NF service producer 402 (e.g., the data producer) receives the request, the NF service producer 402 authenticates the NF service consumer (e.g., the OSF 502 and data collection function 504) and verifies the token provided with the service request. The NF service producer 402 sends the token verification response to the data collection function 504. Based on the response received, the data collection function 504 updates the subscription information to include the additional NF service consumer and sends the data to both the NF service consumers, and for token verification failure, the data collection function 504 rejects the request received by the NF service consumer.

An OSF 502 may additionally, or alternatively, be referred to as a trust evaluation and enabler service function, a security monitoring function, or a security evaluation and monitoring function. The OSF 502 may be an example of a security information and event management (SIEM) function.

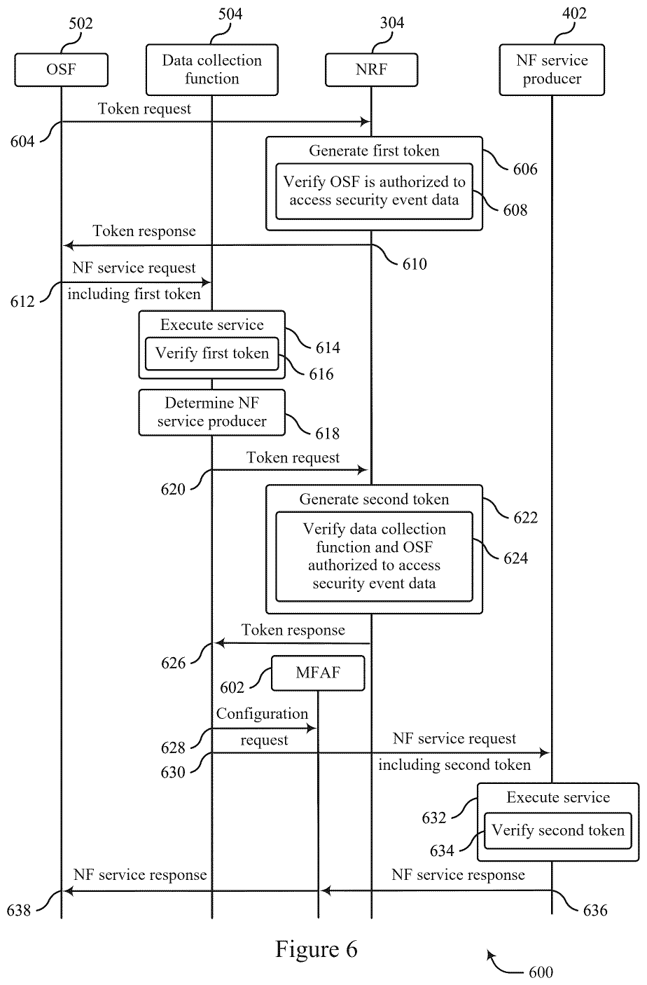

FIG. 6 illustrates an example of a signaling diagram 600 in accordance with aspects of the present disclosure. In some examples, the signaling diagram 600 may implement aspects of the wireless communications system 100, the SBA diagram 200, the signaling diagram 300, the signaling diagram 400, and the signaling diagram 500. The signaling diagram 600 may illustrate an example of an OSF 502, a data collection function 504, an NRF 218, an NF service producer 402, and an MFAF 602 implementing token generation and authorization for security event data collection in a wireless communications system, where the OSF 502 and the data collection function 504 may be examples of an NF service consumer 302 as described with reference to FIG. 3. The NRF 218 may be an example of an NRF 218 as described with reference to FIGS. 2 and 3. The NF service producer 402 may be an example of an NF service producer 402, as described with reference to FIG. 4. Alternative examples of the following may be implemented, where some processes are performed in a different order than described or are not performed. In some cases, processes may include additional features not mentioned below, or further processes may be added.

Although a single (e.g., one) OSF 502 and data collection function 504 is illustrated, any numerical quantity of NF service consumers may implement authorization for security event data collection. The NF service producer 402 may be an example of any NF in a CN (e.g., a CN 106, as described with reference to FIG. 1), an AF, or any other function. Although a single NF service producer 402 is illustrated, any numerical quantity of NF service producers may implement authorization for security event data collection.

In some examples, the OSF 502, the 504, the NRF 218, the NF service producer 402, and the MFAF 602, may implement the enhanced NF profiles and/or enhanced token claims to perform authorization for security event data collection, as described with reference to FIG. 3.

At 604, the OSF 502 transmits a token request to the NRF 218, as described with reference to FIG. 5. At 606, the NRF 218 generates a first token. For example, at 608 the NRF 218 verifies the OSF 502 is authorized to access security event data, as described with reference to FIG. 5. At 610, the NRF 218 transmits a token response to the OSF 502, as described with reference to FIG. 5.

At 612, the OSF 502 transmits an NF service request to the data collection function 504 that includes the first token, as described with reference to FIG. 5. At 614, the data collection function 504 executes the service. For example, at 616 the data collection function 504 verifies the first token and then determines to execute the service, accordingly, as described with reference to FIG. 5.

At 618, the data collection function 504 determines one or more NF service producers 402, as described with reference to FIG. 5. At 620, the data collection function 504 transmits a token request to the NRF 218, as described with reference to FIG. 5. At 622, the NRF 218 generates a second token. For example, at 624, the NRF 218 verifies the data collection function 504 and the OSF 502 are authorized to access the security event data, as described with reference to FIG. 5. At 626, the NRF 218 transmits a token response to the data collection function 504, as described with reference to FIG. 5.

The data collection function 504 sends a token request to the NRF 218 to request service from the MFAF 602, that includes expected NF service names (e.g., security event data exposure), an NF type (e.g., MFAF 602), a source NF (e.g., data collection function 504), security event IDs, and an NF service producer instance ID (e.g., that exposes the security event data). After verifying the data collection function 504, the OSF 502, and/or the MFAF 602 are authorized to access the security event data, the NRF 218 sends the second token (e.g., access_token_data collection function) to the data collection function 504 to consume the services of the MFAF 602. The claims in the second token include an NF instance ID of the data collection function 504, authorized security event IDs, an instance ID of the NF service producer (e.g., that exposes the security event data), and an OSF ID.

At 628, the data collection function 504 transmits a configuration request to an MFAF 602. The configuration request may include the second token (e.g., access_token_data collection function). For example, the data collection function 504 sends an Nmfaf_3daDataManagement_Configure request to the MFAF 602 with the second token.

At 630, the data collection function 504 transmits an NF service request to the NF service producer 402 that includes the second token, as described with referenced to FIG. 5. At 632, the NF service producer 402 executes the service. For example, at 634 the NF service producer 402 verifies the second token and executes the requested service, as described with reference to FIG. 5.

At 636 and at 638, the NF service producer 402 transmits an NF service response to the MFAF 602, and the MFAF 602 transmits the NF service response to the OSF 502, respectively. The NF service responses include the security event data. One or more NF service producers 402 provide the requested security event data to the MFAF 602. The MFAF 602 forwards the received security event data to one or more NF service consumers (e.g., the OSF 502).

In some examples, such as if an additional NF service consumer (e.g., another OSF) requests the data after one or more of the requests and/or token generation in the signaling diagram 500 is already performed, then the additional NF service consumer can perform 506 through 530. When the NF service producer 402 (e.g., the data producer) receives the request, the NF service producer 402 authenticates the NF service consumer (e.g., the OSF 502 and data collection function 504) and verifies the token provided with the service request. The NF service producer 402 sends the token verification response to the data collection function 504. Based on the response received, the data collection function 504 updates the subscription information at the MFAF 602 to include the additional NF service consumer and the MFAF 602 sends the data to both the NF service consumers, and for token verification failure, the data collection function 504 rejects the request received by the NF service consumer.

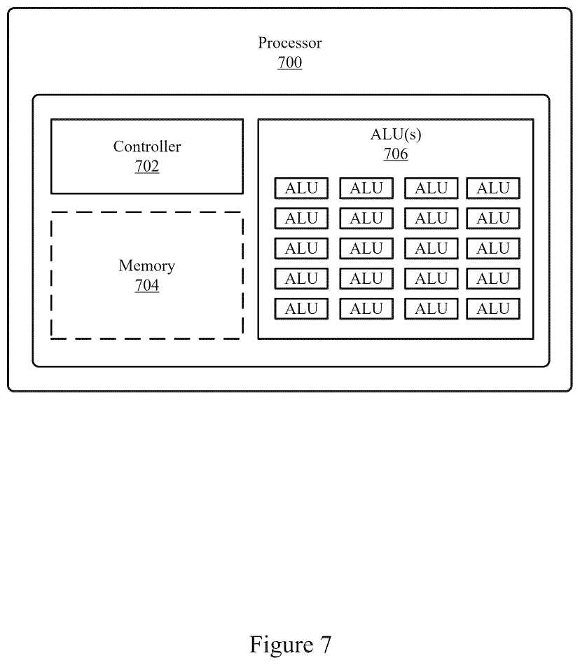

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from at least one second NF, a request for a token to access security event data corresponding to a third NF, generate the token based on a profile of the at least one second NF indicating that the at least one second NF is authorized to access the security event data (e.g., to perform security evaluation and monitoring), and transmit, to the at least one second NF, the token.

Additionally, the processor 700 may be configured to or operable to support any one or combination of the at least one controller configured to cause the processor to receive, from a fourth NF, an additional request for an additional token to access the security event data (e.g., to access the security event data for data collection and to notify the collected data to second NF that performs security evaluation and monitoring), generate the additional token based on a profile of the fourth NF indicating that the fourth NF is authorized to access the security event data, and transmit, to the fourth NF, the additional token. Additionally, or alternatively, the first NF is an NRF, the at least one second NF is at least one OSF, the third NF is an NF service producer, and the fourth NF is a data collection function. Additionally, or alternatively, the profile of the fourth NF includes a set of IEs that indicate at least one of an NF type associated with collection of the security event data, an authorized service associated with the collection, exposure, or notification of the security event data, one or more authorized security event IDs associated with the collection, the exposure, or the notification of the security event data, information associated with the third NF that indicates the third NF is authorized to consume a security event data collection service or a notification service to perform security evaluation and monitoring, an expected service associated with the exposure of the security event data, one or more IDs associated with the security event data, or an expected mode associated with the security event data. Additionally, or alternatively, the token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that indicates the at least one second NF is authorized to access the security event data, or an ID associated with the fourth NF that indicates the fourth NF is authorized to access the security event data.

Additionally, or alternatively, the profile of the at least one second NF includes a set of IEs that indicates at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data. Additionally, or alternatively, the first NF is an NRF, the at least one second NF is at least one of a data collection function or an OSF, and the third NF is an NF service producer.

The processor 700 may be configured to or operable to support at least one controller (e.g., the controller 702) coupled with at least one memory (e.g., the memory 704) and configured to cause the processor to transmit, to a second NF, a request for a token to access security event data corresponding to a third NF, and receive the token based on a profile of the first NF indicating that the first NF is authorized to access the security event data.

Additionally, the processor 700 may be configured to or operable to support any one or combination of the at least one controller configured to cause the processor to transmit, to at least one of the second NF or a fourth NF, a request for the security event data, the request for the security event data including the token, and receive, in response to the request for the security event data, the security event data, where the first NF is an OSF, the second NF is an NRF, the third NF is an NF service producer, and the fourth NF is a data collection function. Additionally, or alternatively, the profile of the first NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data.

Additionally, or alternatively, the token includes one or more parameters that indicate services associated with collection, exposure, or notification of the security event data that the first NF is authorized to access, an authorized target reporting type, one or more IDs associated with the security event data that the first NF is authorized to access, or an ID associated with the first NF that indicates the first NF is authorized to access the security event data. Additionally, or alternatively, the first NF is an OSF, the second NF is an NRF, and the third NF is an NF service producer.

The processor 700 may be configured to or operable to support at least one controller (e.g., the controller 702) coupled with at least one memory (e.g., the memory 704) and configured to cause the processor to receive, from at least one second NF, a first request for security event data corresponding to a third NF, where the first request for the security event data includes a first token based on a profile of the at least one second NF indicating that the at least one second NF is authorized to access the security event data, transmit, to the third NF, a second request for the security event data, where the second request for the security event data includes a second token based on a profile of the at least one second NF and a profile of the first NF indicating that the at least one second NF and the first NF are authorized to access the security event data, receive, from the third NF, the security event data, and transmit, to the at least one second NF, the security event data.

Additionally, the processor 700 may be configured to or operable to support any one or combination of the at least one controller configured to cause the processor to transmit, to a fourth NF, a request for the second token, and receive, in response to the request for the second token, the second token, where the first NF is a data collection function, the at least one second NF is an OSF, the third NF is an NF service producer, and the fourth NF is an NRF. Additionally, or alternatively, the profile of the first NF includes a set of IEs that indicate at least one of an NF type associated with collection of the security event data, an authorized service associated with the collection, exposure, or notification of the security event data, an authorized target reporting type, one or more authorized security event IDs associated with the collection, the exposure, or the notification of the security event data, one or more IDs associated with the security event data, an ID associated with the second NF that indicates the second NF is authorized to access the security event data, an expected service associated with the exposure of the security event data, or an expected mode associated with the security event data.

Additionally, or alternatively, the profile of the at least one second NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with the security event data, an expected target reporting type, an expected mode associated with the security event data, or information corresponding to the collection of the security event data. Additionally, or alternatively, the first token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that is authorized to access the security event data. Additionally, or alternatively, the second token includes one or more parameters that indicate services associated with the security event data that the at least one second NF and the first NF are authorized to access, one or more IDs associated with the security event data that the at least one second NF and the first NF are authorized to access, or respective IDs associated with the second NF and the first NF that indicate the second NF and the first NF are authorized to access the security event data. Additionally, or alternatively, the first NF is a data collection function, the at least one second NF is an OSF, and the third NF is an NF service producer.

The processor 700 may be configured to or operable to support at least one controller (e.g., the controller 702) coupled with at least one memory (e.g., the memory 704) and configured to cause the processor to receive, from a second NF, a request for security event data, where the request for the security event data includes a token based on a profile of the second NF indicating that the second NF is authorized to access the security event data, and transmit, to the second NF, the security event data.

Additionally, the processor 700 may be configured to or operable to support any one or combination of the request for the security event data includes the token based on a profile of a third NF indicating that the third NF is authorized to access the security event data, the first NF is an NF service producer, the second NF is a data collection function, and the third NF is an OSF, and the token includes one or more parameters that indicate services associated with exposure of the security event data that the second NF is authorized to access, an ID associated with the second NF that indicates the second NF is authorized to access and collect the security event data (e.g., to access the security event data for data collection and to notify the collected data to third NF that performs security evaluation and monitoring), an ID associated with the third NF that indicates the third NF is authorized to access the security event data, or one or more IDs associated with the security event data that the second NF is authorized to access.

Additionally, or alternatively, the profile of the second NF includes a set of IEs that indicate at least one of an authorized service associated with collection, exposure, or notification of the security event data, that logging the security event data is supported, that logging the security event data is not supported, one or more IDs associated with the security event data to be exposed, an expected mode associated with the collection of the security event data, one or more IDs associated with one or more NFs that are authorized to access the security event data, or information corresponding to the collection of the security event data. Additionally, or alternatively, the first NF verifies the token by checking if one or more parameters indicated by the token match one or more parameters indicated by the request for the security event data, and where the first NF is an NF service producer and the second NF is at least one of a data collection function or an OSF.

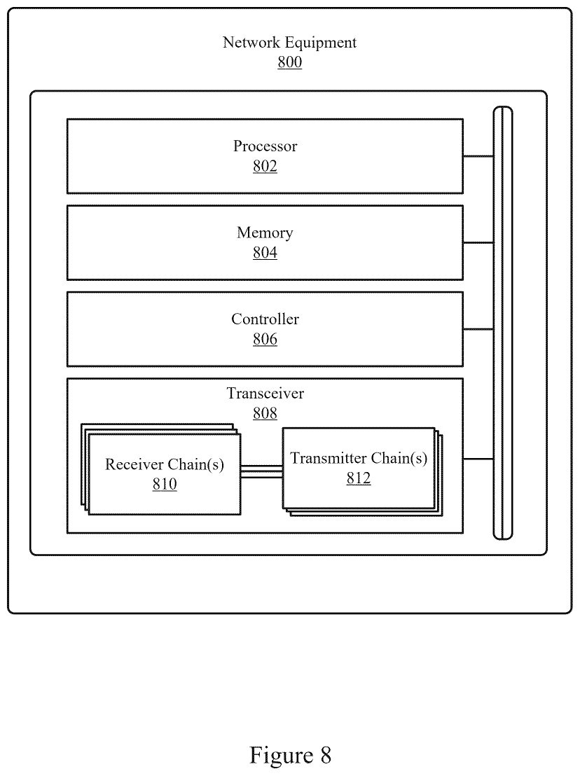

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for receiving, from at least one second NF, a request for a token to access security event data corresponding to a third NF, generating the token based on a profile of the at least one second NF indicating that the at least one second NF is authorized to access the security event data (e.g., to perform security evaluation and monitoring), and transmitting, to the at least one second NF, the token.

Additionally, the NE 800 may be configured to or operable to support any one or combination of receiving, from a fourth NF, an additional request for an additional token to access the security event data (e.g., to access the security event data for data collection and to notify the collected data to second NF that performs security evaluation and monitoring), generating the additional token based on a profile of the fourth NF indicating that the fourth NF is authorized to access the security event data, and transmitting, to the fourth NF, the additional token. Additionally, or alternatively, the first NF is an NRF, the at least one second NF is at least one OSF, the third NF is an NF service producer, and the fourth NF is a data collection function. Additionally, or alternatively, the profile of the fourth NF includes a set of IEs that indicate at least one of an NF type associated with collection of the security event data, an authorized service associated with the collection, exposure, or notification of the security event data, one or more authorized security event IDs associated with the collection, the exposure, or the notification of the security event data, information associated with the third NF that indicates the third NF is authorized to consume a security event data collection service or a notification service to perform security evaluation and monitoring, an expected service associated with the exposure of the security event data, one or more IDs associated with the security event data, or an expected mode associated with the security event data. Additionally, or alternatively, the token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that indicates the at least one second NF is authorized to access the security event data, or an ID associated with the fourth NF that indicates the fourth NF is authorized to access the security event data.

Additionally, or alternatively, the profile of the at least one second NF includes a set of IEs that indicates at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data. Additionally, or alternatively, the first NF is an NRF, the at least one second NF is at least one of a data collection function or an OSF, and the third NF is an NF service producer.

The NE 800 may be configured to or operable to support a means for transmitting, to a second NF, a request for a token to access security event data corresponding to a third NF, and receiving the token based on a profile of the first NF indicating that the first NF is authorized to access the security event data.

Additionally, the NE 800 may be configured to or operable to support any one or combination of transmitting, to at least one of the second NF or a fourth NF, a request for the security event data, the request for the security event data including the token, and receiving, in response to the request for the security event data, the security event data, where the first NF is an OSF, the second NF is an NRF, the third NF is an NF service producer, and the fourth NF is a data collection function. Additionally, or alternatively, the profile of the first NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data.

Additionally, or alternatively, the token includes one or more parameters that indicate services associated with collection, exposure, or notification of the security event data that the first NF is authorized to access, an authorized target reporting type, one or more IDs associated with the security event data that the first NF is authorized to access, or an ID associated with the first NF that indicates the first NF is authorized to access the security event data. Additionally, or alternatively, the first NF is an OSF, the second NF is an NRF, and the third NF is an NF service producer.

The NE 800 may be configured to or operable to support a means for receiving, from at least one second NF, a first request for security event data corresponding to a third NF, where the first request for the security event data includes a first token based on a profile of the at least one second NF indicating that the at least one second NF is authorized to access the security event data, transmitting, to the third NF, a second request for the security event data, where the second request for the security event data includes a second token based on a profile of the at least one second NF and a profile of the first NF indicating that the at least one second NF and the first NF are authorized to access the security event data, receiving, from the third NF, the security event data, and transmitting, to the at least one second NF, the security event data.

Additionally, the NE 800 may be configured to or operable to support any one or combination of transmitting, to a fourth NF, a request for the second token, and receiving, in response to the request for the second token, the second token, where the first NF is a data collection function, the at least one second NF is an OSF, the third NF is an NF service producer, and the fourth NF is an NRF. Additionally, or alternatively, the profile of the first NF includes a set of IEs that indicate at least one of an NF type associated with collection of the security event data, an authorized service associated with the collection, exposure, or notification of the security event data, an authorized target reporting type, one or more authorized security event IDs associated with the collection, the exposure, or the notification of the security event data, one or more IDs associated with the security event data, an ID associated with the second NF that indicates the second NF is authorized to access the security event data, an expected service associated with the exposure of the security event data, or an expected mode associated with the security event data.

Additionally, or alternatively, the profile of the at least one second NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with the security event data, an expected target reporting type, an expected mode associated with the security event data, or information corresponding to the collection of the security event data. Additionally, or alternatively, the first token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that is authorized to access the security event data. Additionally, or alternatively, the second token includes one or more parameters that indicate services associated with the security event data that the at least one second NF and the first NF are authorized to access, one or more IDs associated with the security event data that the at least one second NF and the first NF are authorized to access, or respective IDs associated with the second NF and the first NF that indicate the second NF and the first NF are authorized to access the security event data. Additionally, or alternatively, the first NF is a data collection function, the at least one second NF is an OSF, and the third NF is an NF service producer.

The NE 800 may be configured to or operable to support a means for receiving, from a second NF, a request for security event data, where the request for the security event data includes a token based on a profile of the second NF indicating that the second NF is authorized to access the security event data, and transmitting, to the second NF, the security event data.

Additionally, the NE 800 may be configured to or operable to support any one or combination of the request for the security event data includes the token based on a profile of a third NF indicating that the third NF is authorized to access the security event data, the first NF is an NF service producer, the second NF is a data collection function, and the third NF is an OSF, and the token includes one or more parameters that indicate services associated with exposure of the security event data that the second NF is authorized to access, an ID associated with the second NF that indicates the second NF is authorized to access and collect the security event data (e.g., to access the security event data for data collection and to notify the collected data to third NF that performs security evaluation and monitoring), an ID associated with the third NF that indicates the third NF is authorized to access the security event data, or one or more IDs associated with the security event data that the second NF is authorized to access.

Additionally, or alternatively, the profile of the second NF includes a set of IEs that indicate at least one of an authorized service associated with collection, exposure, or notification of the security event data, that logging the security event data is supported, that logging the security event data is not supported, one or more IDs associated with the security event data to be exposed, an expected mode associated with the collection of the security event data, one or more IDs associated with one or more NFs that are authorized to access the security event data, or information corresponding to the collection of the security event data. Additionally, or alternatively, the first NF verifies the token by checking if one or more parameters indicated by the token match one or more parameters indicated by the request for the security event data, and where the first NF is an NF service producer and the second NF is at least one of a data collection function or an OSF.

Additionally, or alternatively, the NE 800 may support at least one memory (e.g., the memory 804) and at least one processor (e.g., the processor 802) coupled with the at least one memory and configured to cause the NE to receive, from at least one second NF, a request for a token to access security event data corresponding to a third NF, generate the token based on a profile of the at least one second NF indicating that the at least one second NF is authorized to access the security event data (e.g., to perform security evaluation and monitoring), and transmit, to the at least one second NF, the token.

Additionally, the NE 800 may be configured to support any one or combination of the processor further configured to cause the NE 800 to receive, from a fourth NF, an additional request for an additional token to access the security event data (e.g., to access the security event data for data collection and to notify the collected data to second NF that performs security evaluation and monitoring), generate the additional token based on a profile of the fourth NF indicating that the fourth NF is authorized to access the security event data, and transmit, to the fourth NF, the additional token. Additionally, or alternatively, the first NF is an NRF, the at least one second NF is at least one OSF, the third NF is an NF service producer, and the fourth NF is a data collection function. Additionally, or alternatively, the profile of the fourth NF includes a set of IEs that indicate at least one of an NF type associated with collection of the security event data, an authorized service associated with the collection, exposure, or notification of the security event data, one or more authorized security event IDs associated with the collection, the exposure, or the notification of the security event data, information associated with the third NF that indicates the third NF is authorized to consume a security event data collection service or a notification service to perform security evaluation and monitoring, an expected service associated with the exposure of the security event data, one or more IDs associated with the security event data, or an expected mode associated with the security event data. Additionally, or alternatively, the token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that indicates the at least one second NF is authorized to access the security event data, or an ID associated with the fourth NF that indicates the fourth NF is authorized to access the security event data.

Additionally, or alternatively, the profile of the at least one second NF includes a set of IEs that indicates at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data. Additionally, or alternatively, the first NF is an NRF, the at least one second NF is at least one of a data collection function or an OSF, and the third NF is an NF service producer.

Additionally, or alternatively, the NE 800 may support at least one memory (e.g., the memory 804) and at least one processor (e.g., the processor 802) coupled with the at least one memory and configured to cause the NE to transmit, to a second NF, a request for a token to access security event data corresponding to a third NF, and receive the token based on a profile of the first NF indicating that the first NF is authorized to access the security event data.

Additionally, the NE 800 may be configured to support any one or combination of the processor further configured to cause the NE 800 to transmit, to at least one of the second NF or a fourth NF, a request for the security event data, the request for the security event data including the token, and receive, in response to the request for the security event data, the security event data, where the first NF is an OSF, the second NF is an NRF, the third NF is an NF service producer, and the fourth NF is a data collection function. Additionally, or alternatively, the profile of the first NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with expected security event data, an expected target reporting type, an expected mode associated with the security event data, or information corresponding to the collection of the security event data.

Additionally, or alternatively, the token includes one or more parameters that indicate services associated with collection, exposure, or notification of the security event data that the first NF is authorized to access, an authorized target reporting type, one or more IDs associated with the security event data that the first NF is authorized to access, or an ID associated with the first NF that indicates the first NF is authorized to access the security event data. Additionally, or alternatively, the first NF is an OSF, the second NF is an NRF, and the third NF is an NF service producer.

Additionally, or alternatively, the NE 800 may support at least one memory (e.g., the memory 804) and at least one processor (e.g., the processor 802) coupled with the at least one memory and configured to cause the NE to receive, from at least one second NF, a first request for security event data corresponding to a third NF, where the first request for the security event data includes a first token based on a profile of the at least one second NF indicating that the at least one second NF is authorized to access the security event data, transmit, to the third NF, a second request for the security event data, where the second request for the security event data includes a second token based on a profile of the at least one second NF and a profile of the first NF indicating that the at least one second NF and the first NF are authorized to access the security event data, receive, from the third NF, the security event data, and transmit, to the at least one second NF, the security event data.

Additionally, the NE 800 may be configured to support any one or combination of the processor further configured to cause the NE 800 to transmit, to a fourth NF, a request for the second token, and receive, in response to the request for the second token, the second token, where the first NF is a data collection function, the at least one second NF is an OSF, the third NF is an NF service producer, and the fourth NF is an NRF. Additionally, or alternatively, the profile of the first NF includes a set of IEs that indicate at least one of an NF type associated with collection of the security event data, an authorized service associated with the collection, exposure, or notification of the security event data, an authorized target reporting type, one or more authorized security event IDs associated with the collection, the exposure, or the notification of the security event data, one or more IDs associated with the security event data, an ID associated with the second NF that indicates the second NF is authorized to access the security event data, an expected service associated with the exposure of the security event data, or an expected mode associated with the security event data.

Additionally, or alternatively, the profile of the at least one second NF includes a set of IEs that indicate at least one of an NF type associated with collection of the security event data, an NF type associated with an OSF, an NF type associated with a security evaluation and monitoring function, NF identification information, an expected service associated with the collection, exposure, or notification of the security event data, one or more IDs associated with the security event data, an expected target reporting type, an expected mode associated with the security event data, or information corresponding to the collection of the security event data. Additionally, or alternatively, the first token includes one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that is authorized to access the security event data. Additionally, or alternatively, the second token includes one or more parameters that indicate services associated with the security event data that the at least one second NF and the first NF are authorized to access, one or more IDs associated with the security event data that the at least one second NF and the first NF are authorized to access, or respective IDs associated with the second NF and the first NF that indicate the second NF and the first NF are authorized to access the security event data. Additionally, or alternatively, the first NF is a data collection function, the at least one second NF is an OSF, and the third NF is an NF service producer.

Additionally, or alternatively, the NE 800 may support at least one memory (e.g., the memory 804) and at least one processor (e.g., the processor 802) coupled with the at least one memory and configured to cause the NE to receive, from a second NF, a request for security event data, where the request for the security event data includes a token based on a profile of the second NF indicating that the second NF is authorized to access the security event data, and transmit, to the second NF, the security event data.

Additionally, the NE 800 may be configured to support any one or combination of the request for the security event data includes the token based on a profile of a third NF indicating that the third NF is authorized to access the security event data, the first NF is an NF service producer, the second NF is a data collection function, and the third NF is an OSF, and the token includes one or more parameters that indicate services associated with exposure of the security event data that the second NF is authorized to access, an ID associated with the second NF that indicates the second NF is authorized to access and collect the security event data (e.g., to access the security event data for data collection and to notify the collected data to third NF that performs security evaluation and monitoring), an ID associated with the third NF that indicates the third NF is authorized to access the security event data, or one or more IDs associated with the security event data that the second NF is authorized to access.

Additionally, or alternatively, the profile of the second NF includes a set of IEs that indicate at least one of an authorized service associated with collection, exposure, or notification of the security event data, that logging the security event data is supported, that logging the security event data is not supported, one or more IDs associated with the security event data to be exposed, an expected mode associated with the collection of the security event data, one or more IDs associated with one or more NFs that are authorized to access the security event data, or information corresponding to the collection of the security event data. Additionally, or alternatively, the first NF verifies the token by checking if one or more parameters indicated by the token match one or more parameters indicated by the request for the security event data, and where the first NF is an NF service producer and the second NF is at least one of a data collection function or an OSF.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

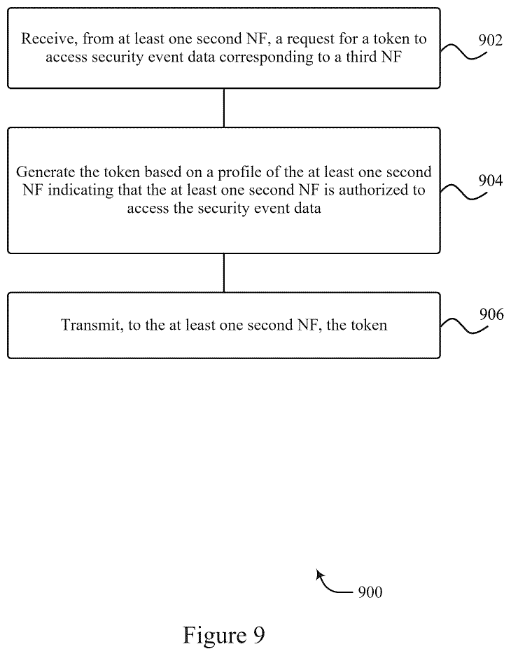

FIG. 9 illustrates a flowchart of a method 900 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include receiving, from at least one second NF, a request for a token to access security event data corresponding to a third NF. The operations of 902 may be performed in accordance with examples as described herein. In some implementations, aspects of the operations of 902 may be performed by a NE as described with reference to FIG. 8.

At 904, the method may include generating the token based on a profile of the at least one second NF indicating that the at least one second NF is authorized to access the security event data. The operations of 904 may be performed in accordance with examples as described herein. In some implementations, aspects of the operations of 904 may be performed by a NE as described with reference to FIG. 8.

At 906, the method may include transmitting, to the at least one second NF, the token. The operations of 906 may be performed in accordance with examples as described herein. In some implementations, aspects of the operations of 906 may be performed by a NE as described with reference to FIG. 8.

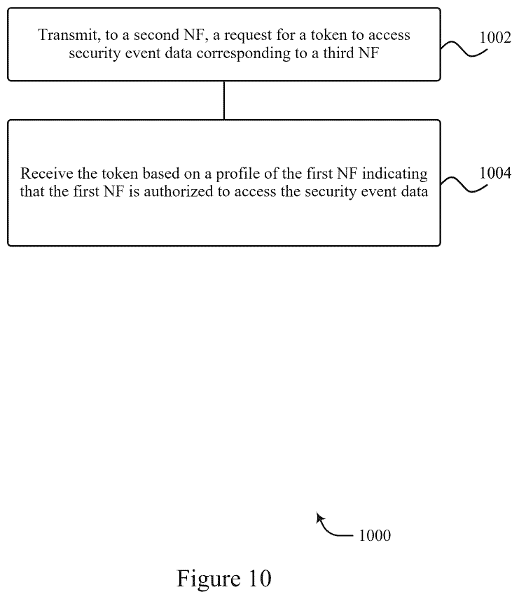

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting, to a second NF, a request for a token to access security event data corresponding to a third NF. The operations of 1002 may be performed in accordance with examples as described herein. In some implementations, aspects of the operations of 1002 may be performed by a NE as described with reference to FIG. 8.

At 1004, the method may include receiving the token based on a profile of the first NF indicating that the first NF is authorized to access the security event data. The operations of 1004 may be performed in accordance with examples as described herein. In some implementations, aspects of the operations of 1004 may be performed by a NE as described with reference to FIG. 8.

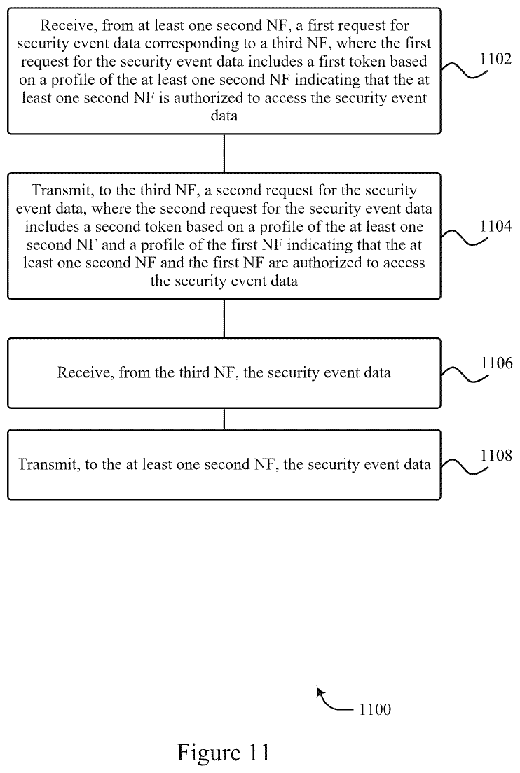

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include receiving, from at least one second NF, a first request for security event data corresponding to a third NF, where the first request for the security event data includes a first token based on a profile of the at least one second NF indicating that the at least one second NF is authorized to access the security event data. The operations of 1102 may be performed in accordance with examples as described herein. In some implementations, aspects of the operations of 1102 may be performed by a NE as described with reference to FIG. 8.

At 1104, the method may include transmitting, to the third NF, a second request for the security event data, where the second request for the security event data includes a second token based on a profile of the at least one second NF and a profile of the first NF indicating that the at least one second NF and the first NF are authorized to access the security event data. The operations of 1104 may be performed in accordance with examples as described herein. In some implementations, aspects of the operations of 1104 may be performed by a NE as described with reference to FIG. 8.

At 1106, the method may include receiving, from the third NF, the security event data. The operations of 1106 may be performed in accordance with examples as described herein. In some implementations, aspects of the operations of 1106 may be performed by a NE as described with reference to FIG. 8.

At 1108, the method may include transmitting, to the at least one second NF, the security event data. The operations of 1108 may be performed in accordance with examples as described herein. In some implementations, aspects of the operations of 1108 may be performed by a NE as described with reference to FIG. 8.

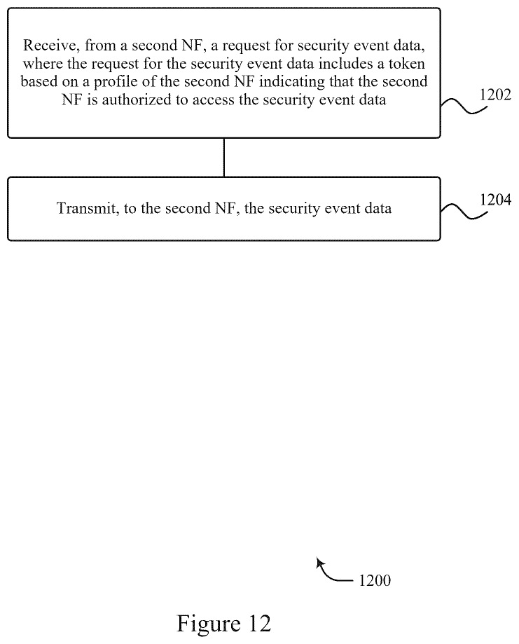

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include receiving, from a second NF, a request for security event data, where the request for the security event data includes a token based on a profile of the second NF indicating that the second NF is authorized to access the security event data. The operations of 1202 may be performed in accordance with examples as described herein. In some implementations, aspects of the operations of 1202 may be performed by a NE as described with reference to FIG. 8.

At 1204, the method may include transmitting, to the second NF, the security event data. The operations of 1204 may be performed in accordance with examples as described herein. In some implementations, aspects of the operations of 1204 may be performed by a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) to implement a first network function (NF) for wireless communication, comprising:
at least one memory; and
at least one processor coupled with the at least one memory and configured to cause the NE to:
receive, from at least one second NF, a request for a token to access security event data corresponding to a third NF;
generate the token based at least in part on a profile of the at least one second NF indicating that the at least one second NF is authorized to access the security event data; and
transmit, to the at least one second NF, the token.

2. The NE of claim 1, wherein the at least one processor is further configured to cause the NE to:
receive, from a fourth NF, an additional request for an additional token to access the security event data;
generate the additional token based at least in part on a profile of the fourth NF indicating that the fourth NF is authorized to access the security event data; and
transmit, to the fourth NF, the additional token, wherein:
the first NF is a network repository function (NRF), the at least one second NF is at least one operator security function (OSF), the third NF is an NF service producer, and the fourth NF is a data collection function;
the profile of the fourth NF comprises a plurality of information elements (IEs) that indicate at least one of an NF type associated with collection of the security event data, an authorized service associated with the collection, exposure, or notification of the security event data, one or more authorized security event identifiers (IDs) associated with the collection, the exposure, or the notification of the security event data, information associated with the third NF that indicates the third NF is authorized to consume a security event data collection service or a notification service to perform security evaluation and monitoring, an expected service associated with the exposure of the security event data, one or more IDs associated with the security event data, or an expected mode associated with the security event data; and
the token comprises one or more parameters that indicate services associated with collection, exposure, or notification of the security event data that the at least one second NF is authorized to access, an authorized target reporting type, one or more IDs associated with the security event data that the at least one second NF is authorized to access, an ID associated with the at least one second NF that indicates the at least one second NF is authorized to access the security event data, or an ID associated with the fourth NF that indicates the fourth NF is authorized to access the security event data.

3. The NE of claim 1, wherein the profile of the at least one second NF comprises a plurality of information elements (IEs) that indicates at least one of an NF type associated with collection of the security event data, an NF type associated with an operator security function (OSF), an NF type associated with a security evaluation and monitoring function, NF identification information, an expected service associated with the collection, exposure, or notification of the security event data, one or more identifiers (IDs) associated with expected security event data, an expected target reporting type, an expected mode associated with the security event data, or information corresponding to the collection of the security event data.

4. The NE of claim 1, wherein the first NF is a network repository function (NRF), the at least one second NF is at least one of a data collection function or an operator security function (OSF), and the third NF is an NF service producer.

5. A network equipment (NE) to implement a first network function (NF) for wireless communication, comprising:
at least one memory; and
at least one processor coupled with the at least one memory and configured to cause the NE to:
transmit, to a second NF, a request for a token to access security event data corresponding to a third NF; and
receive the token based at least in part on a profile of the first NF indicating that the first NF is authorized to access the security event data.

6. The NE of claim 5, wherein the at least one processor is further configured to cause the NE to:
transmit, to at least one of the second NF or a fourth NF, a request for the security event data, the request for the security event data comprising the token; and
receive, in response to the request for the security event data, the security event data, wherein the first NF is an operator security function (OSF), the second NF is a network repository function (NRF), the third NF is an NF service producer, and the fourth NF is a data collection function.

7. The NE of claim 5, wherein the profile of the first NF comprises a plurality of information elements (IEs) that indicate at least one of an NF type associated with collection of the security event data, an NF type associated with an operator security function (OSF), an NF type associated with a security evaluation and monitoring function, NF identification information, an expected service associated with the collection, exposure, or notification of the security event data, one or more identifiers (IDs) associated with expected security event data, an expected target reporting type, an expected mode associated with the security event data, or information corresponding to the collection of the security event data.

8. The NE of claim 5, wherein the token comprises one or more parameters that indicate services associated with collection, exposure, or notification of the security event data that the first NF is authorized to access, an authorized target reporting type, one or more identifiers (IDs) associated with the security event data that the first NF is authorized to access, or an ID associated with the first NF that indicates the first NF is authorized to access the security event data.

9. The NE of claim 5, wherein the first NF is an operator security function (OSF), the second NF is a network repository function (NRF), and the third NF is an NF service producer.

10. A network equipment (NE) to implement a first network function (NF) for wireless communication, comprising:
at least one memory; and
at least one processor coupled with the at least one memory and configured to cause the NE to:
receive, from at least one second NF, a first request for security event data corresponding to a third NF, wherein the first request for the security event data comprises a first token based at least in part on a profile of the at least one second NF indicating that the at least one second NF is authorized to access the security event data;
transmit, to the third NF, a second request for the security event data, wherein the second request for the security event data comprises a second token based at least in part on a profile of the at least one second NF and a profile of the first NF indicating that the at least one second NF and the first NF are authorized to access the security event data;
receive, from the third NF, the security event data; and
transmit, to the at least one second NF, the security event data.

11. The NE of claim 10, wherein the at least one processor is further configured to cause the NE to:
transmit, to a fourth NF, a request for the second token; and
receive, in response to the request for the second token, the second token, wherein the first NF is a data collection function, the at least one second NF is an operator security function (OSF), the third NF is an NF service producer, and the fourth NF is a network repository function (NRF).

12. The NE of claim 10, wherein the profile of the first NF comprises a plurality of information elements (IEs) that indicate at least one of an NF type associated with collection of the security event data, an authorized service associated with the collection, exposure, or notification of the security event data, an authorized target reporting type, one or more authorized security event identifiers (IDs) associated with the collection, the exposure, or the notification of the security event data, one or more IDs associated with the security event data, an ID associated with the second NF that indicates the second NF is authorized to access the security event data, an expected service associated with the exposure of the security event data, or an expected mode associated with the security event data.

13. The NE of claim 10, wherein the profile of the at least one second NF comprises a plurality of information elements (IEs) that indicate at least one of an NF type associated with collection of the security event data, an NF type associated with an operator security function (OSF), an NF type associated with a security evaluation and monitoring function, NF identification information, an expected service associated with the collection, exposure, or notification of the security event data, one or more identifiers (IDs) associated with the security event data, an expected target reporting type, an expected mode associated with the security event data, or information corresponding to the collection of the security event data.

14. The NE of claim 10, wherein the first token comprises one or more parameters that indicate services associated with collection, exposure, or notification of the security event data that the at least one second NF is authorized to access, an authorized target reporting type, one or more identifiers (IDs) associated with the security event data that the at least one second NF is authorized to access, an ID associated with the at least one second NF that is authorized to access the security event data.

15. The NE of claim 10, wherein the second token comprises one or more parameters that indicate services associated with the security event data that the at least one second NF and the first NF are authorized to access, one or more identifiers (IDs) associated with the security event data that the at least one second NF and the first NF are authorized to access, or respective IDs associated with the second NF and the first NF that indicate the second NF and the first NF are authorized to access the security event data.

16. The NE of claim 10, wherein the first NF is a data collection function, the at least one second NF is an operator security function (OSF), and the third NF is an NF service producer.

17. A network equipment (NE) to implement a first network function (NF) for wireless communication, comprising:
at least one memory; and
at least one processor coupled with the at least one memory and configured to cause the NE to:
receive, from a second NF, a request for security event data, wherein the request for the security event data comprises a token based at least in part on a profile of the second NF indicating that the second NF is authorized to access the security event data; and
transmit, to the second NF, the security event data.

18. The NE of claim 17, wherein:
the request for the security event data comprises the token based at least in part on a profile of a third NF indicating that the third NF is authorized to access the security event data;
the first NF is an NF service producer, the second NF is a data collection function, and the third NF is an operator security function (OSF); and
the token comprises one or more parameters that indicate services associated with exposure of the security event data that the second NF is authorized to access, an identifier (ID) associated with the second NF that indicates the second NF is authorized to access and collect the security event data, an ID associated with the third NF that indicates the third NF is authorized to access the security event data, or one or more IDs associated with the security event data that the second NF is authorized to access.

19. The NE of claim 17, wherein the profile of the second NF comprises a plurality of information elements (IEs) that indicate at least one of an authorized service associated with collection, exposure, or notification of the security event data, that logging the security event data is supported, that logging the security event data is not supported, one or more identifiers (IDs) associated with the security event data to be exposed, an expected mode associated with the collection of the security event data, one or more IDs associated with one or more NFs that are authorized to access the security event data, or information corresponding to the collection of the security event data.

20. The NE of claim 17, wherein the first NF verifies the token by checking if one or more parameters indicated by the token match one or more parameters indicated by the request for the security event data, and wherein the first NF is an NF service producer and the second NF is at least one of a data collection function or an operator security function (OSF).
